(19) United States
(12) Patent Application Publication
(10) Pub. No.: US 2006/0035033 A1
(43) Pub. Date: Feb. 16, 2006

(54) Spray coating method, spray coating device and inkjet recording sheet

(75) Inventors: Kiyokazu Tanahashi, Tokyo (JP); Kiyoshi Endo, Kanagawa (JP); Tomohiko Sakai, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/194,943

(22) Filed: Aug. 2, 2005

(30) Foreign Application Priority Data
Aug. 10, 2004 (JP) JP2004-233132
Dec. 22, 2004 (JP) JP2004-370920

(51) Int. Cl. B05D 7/00; B05C 5/00; B05C 3/02

(52) U.S. Cl. 427/421.1; 118/300; 118/407; 118/419

(57) ABSTRACT

A spray coating device for coating of a surface layer of an inkjet recording sheet, to form a surface layer by spraying coating solution onto at least one layer of ink absorption layer formed on a substrate is composed of a backup roller to support a substrate and to carry out a continuous conveyance of the substrate, a spray coater placed near a substrate to carry out spray coating of coating solution onto the substrate and a coating solution scatter prevention means to prevent sprayed coating solution from scattering, including a body having a box-shaped structure with an opening on a side of the spray coater and a suction means connected to the body to reduce pressure in the body.

This application is based on Japanese Patent Application Nos. 2004-233132 filed on Aug. 10, 2004 and 2004-370920 filed on Dec. 22, 2004 in Japanese Patent Office, the entire content of which is hereby incorporated by reference.

### BACKGROUND OF THE INVENTION

The present invention relates to a spray coating method for a surface layer on an inkjet recording sheet (hereinafter referred to as a recording sheet), a spray coating device for a surface layer and the inkjet recording sheet on which spraying of coating solution on an ink absorption layer forms a surface layer.

Inkjet recording is conducted by spraying minute droplets of ink onto a recording sheet, adhering by using various operational principles to record images or letters. It has advantages such as relatively high speed, low noise and easy application of multiple colors. Recently the quality of printer images has been improved to reach the level of photography images and therefore the recording sheets are required to realize the quality of photography images and reproduce the feel of a silver halide photograph (gloss, smoothness and stiffness).

As one method to reproduce the feel of a silver halide photograph, a so-called swelling type recording sheet is known on which a hydrophilic binder such as gelatin or polyvinyl alcohol is coated on a substrate. However, a recording sheet produced by this method has shortcomings such as slow ink absorption, tackiness of the surface after printing and easy bleeding of the image affected by humidity during storage. Specifically, because the ink absorption speed is slow, bleeding between different colors or color shading (beading) is easily occurs due to a mixture of droplets of inks before the absorption, and therefore it is difficult to obtain an image of similar quality to a silver halide photograph.

A method which is becoming a mainstay instead of the above swelling type is a so-called air space type. Because the sheet has a large number of porous inorganic particles in the ink layer and these porous inorganic particles absorb ink, a high absorption speed is characterized. Examples of this kind of air space type recording sheet are described in Tokaihei Nos. 10-119423, 10-119424, 10-175364, 10-193776, 10-193776, 10-217601, 11-20300, 11-106694, 11-321079, 11-348410, 10-178126, and 11-348409, Tokkai Nos. 2000-27093, 2000-94830, 2000-158807, 2000-211241, and others.

On the other hand, in addition to image quality and feel, requirements for durability and image storage stability have become higher and a number of attempts have been made to allow light stability, humidity resistance and water resistance to reach the level of silver halide photography. As examples of the case of light stability, a large number of technologies are disclosed described in Tokkaisyou Nos. 57-74192, 57-87989, 57-74193, 58-152072, and 64-36479, Tokkaihei Nos. 1-95091, 1-115677, 3-13376, 4-7189, 7-195824, 8-25796, 11-321090, and 11-277893, Tokkai No. 2000-37951, and others.

In the case of an air space type recording sheet, one problem is that it tends to easily discolor by traces of active noxious gases in the air such as ozone, oxidants, SO_{X}, NOₓ and the like due to the space structure. Specifically, phthalocyanine water-based dye which is employed for ordinary color inkjet printer tends to be subject to discoloration.

A method is under examination to provide a surface layer on the ink absorption layer as a countermeasure against problems related to the air space structure of an ink absorption layer. The method is effective because it prevents active noxious gasses in the air such as ozone, oxidants, SOₓ and NOₓ from entering the air space structure by providing the surface layer. A technique is known in which a 0.5 to 30 μm transparent polymer membrane is provided as described in Tokkaihei No. 7-237348.

As a method to provide a surface layer, block coating, rotogravure roll coating and extrusion coating are utilized for coating on the ink absorption layer, however there are the following shortcomings of these coating methods.

1) The time efficiency is low because it is difficult to increase the coating speed to exceed 50 m/min.

2) Interference non-uniformity tends to easily occur on the coated surface, reducing the product value.

3) Since thickness distribution of the coating is unstable, it is difficult to obtain a uniformly thick layer and it is disadvantageous to prevent entrance of gases.

4) Since coating of a 5 to 20 μm thin layer is difficult, the recording sheet is colored by an influence of recording sheet thickness, further, increases the drying process load.

For these reasons, for a surface layer to be protected from entrance of noxious gases, coating of the surface layer by spray coating using a spray coater is employed as a coating method for thin and uniform coating. For example, when coating solution is sprayed across the coating width of the direction crossing the conveyance direction of a substrate to form a coating solution layer (surface layer) on the substrate, scattering of the coating solution results. Known countermeasure are a spray coating method and a spray coating device in which a spray device is used wherein a spray coater is installed in its casing, which is maintained under reduced pressure (for example, refer to Patent Document 1).

In the case of the spray coating device described in Patent Document 1, it is effective for the prevention of scattering of coating solution sprayed in the whole coating process line, however it includes the following problems.

1) Because the spray coating device is installed in an sealed casing, adjustment of spray condition of coating solution from the spray coater is carried out by observing the conditions of the coated coating solution on a substrate, and therefore, waste of the substrate and the coating solution is large.

2) Depending on the degree of pressure reduction, there is a high possibility that droplets of the coating solution in the spray state are sucked away prior to reaching the substrate, which reduces coating yield.

3) There is a possibility that stray drops of coating solution once adhered to the walls of the casing may fall onto a coated layer and cause defects.

4) There is a possibility that droplets of unused sprayed coating solution may be scattered through gaps between the casing wall containing the spray coating device and a substrate, and the scattered droplets may adhere to the substrate to cause coating non-uniformity. Further, scattered droplets may cause staining within the coating process line.

5) Because of spray pressure, there is a possibility that the substrate may flutter resulting in mis-feeding of the substrate and may scrape off portions of an ink absorption layer and the coating solution surface soon after coating by contact with the casing.

Under such circumstances, when a recording sheet is produced by forming a surface layer by spraying coating solution on at least one ink absorption layer formed on a substrate with a spray coating device, it is desired that developed is an effective spraying method for a surface layer on a recording sheet, a spray coating device for a surface layer coating and a recording sheet wherein condition setting of spray coater is easier, waste of a substrate and coating solution is small, the coating yield is high and coating defects by a dropping of coating solution and fluttering of the substrate during the coating process is prevented.

[Patent Document 1] Tokkai No. 2004-90330

### SUMMARY OF THE INVENTION

The present invention is created in view of the above targets, and the objective is to provide a spraying method for a surface layer on a recording sheet, a spray coating device for coating a surface layer and a recording sheet wherein condition setting of the spray coater is easy, waste of a substrate and coating solution is small, coating yield is high and coating defects caused by dropping of coating solution and fluttering of the substrate is prevented during the coating process to provide stable coating for a long time when a recording sheet is produced by forming a surface layer by spraying coating solution on at least one ink absorption layer formed on a substrate with a spray coating device.

The above objective of the present invention is achieved by the following configuration.

(A) A spray coating device for coating of a surface layer of an inkjet recording sheet, to form a surface layer by spraying coating solution onto at least one layer of ink absorption layer formed on a substrate, comprising: a backup roller to support a substrate and to carry out a continuous conveyance of the substrate; a spray coater placed near a substrate to carry out spray coating of coating solution onto the substrate; and a coating solution scatter prevention means to prevent sprayed coating solution from scattering; wherein the coating solution scatter prevention means comprises: a body having a box-shaped structure with an opening on a side of the spray coater; a suction device connected to the body to reduce pressure in the body; wherein the coating solution scatter prevention means is positioned in contact with a wall of the spray coater extending in a longitudinal direction of the spray coater and close to an circumferential surface of the backup roller so that a part of the opening is ensured between the spray coater and a substrate.

(B) A spray coating method for coating of a surface layer of an inkjet recording sheet, to form a surface layer by spraying coating solution onto at least one layer of ink absorption layer formed on a substrate by using a spray coating device, comprising steps of: conveying a substrate continuously by a backup roller; carrying out spray coating of coating solution onto a substrate with a spray coater near the backup roller; and preventing sprayed coating solution from scattering by reducing pressure in a body; wherein a coating solution scatter prevention means which includes the body having a box-shaped structure with an opening on a side of the spray coater and a suction device connected to the body to reduce pressure in the body is positioned in contact with a wall of the spray coater extending in a longitudinal direction of the spray coater and close to an circumferential surface of the backup roller so that a part of the opening is ensured between the spray coater and a substrate.

(C) An inkjet recording sheet, wherein the inkjet recording sheet is produced by the spray coating device (A).

Cost reduction, improvement of productivity and quality have become possible by providing a spraying method for a surface layer on a recording sheet, a spray coating device for coating a surface layer and a recording sheet wherein condition setting of the spray coater is easier, waste of a substrate and coating solution is small, the coating yield is high and coating defects by a dropping of coating solution as well as fluttering of the substrate during the coating process are prevented when a recording sheet is produced by forming a surface layer by spraying coating solution on at least one ink absorption layer formed on a substrate with a spray coating device.

### BRIEF DESCRIPTION OF THE DRAWINGS

FIG. 1 is a schematic diagram showing an example of coating production line of recording sheets in which a spray coating device is stationed.

FIG. 2 is a schematic diagram showing an example of coating production line of recording sheets in which a spray coating device is stationed.

FIG. 3 is an enlarged schematic plan view of the portion indicated with X of FIG. 1.

FIG. 4 is an enlarged schematic diagram of the position shown X in FIG. 1.

FIG. 5 is an enlarged diagram of portion Y in FIG. 4.

FIG. 6 is an enlarged schematic diagram showing a coating condition of the spray coater shown in FIG. 1.

FIG. 7 is an enlarged schematic diagram of portion indicated with Z in FIG. 4.

FIG. 8 is an exploded schematic perspective diagram of spray coater (curtain spray coater) shown in FIGS. 1 to 7.

FIG. 9 is an enlarged schematic diagram of the portion indicated by symbol X in FIG. 2.

FIG. 10 is a schematic diagram showing the location of spray coating device shown in FIG. 9 against a substrate.

FIG. 11 is a schematic flowchart showing movement of the spray coater, the monitoring mechanism and the shutter before starting of coating till the coating start of the spray coating device shown in FIG. 2.

FIG. 12 is an enlarged diagram of the portion indicated by symbol Y in S1 of FIG. 11.

### DETAILED DESCRIPTION OF THE PREFERRED EMBODIMENT

Preferred embodiments to achieve the aforementioned objective of this invention will be explained.

(1) The spray coating device (A), further comprising: a monitoring device to monitor a spray condition of coating solution sprayed from the spray coater.

(2) The spray coating device (A), comprising: a transfer device to transfer the spray coater; and a monitoring mechanism to transfer the monitoring device; wherein by the transfer device, the spray coater is transferred from a standby position to a coating position when coating starts and is transferred from the coating position to the standby position after coating finishes and wherein the monitoring mechanism is positioned in the standby position.

(3) The spray coating device (A), wherein an area of the opening is 100 to 700 percent relative to a spray area and a gas suction quantity of the suction device is 100 to 300 percent relative to an air supply quantity of the spray coater.

(4) The spray coating device (A), further comprising: a shutter which opens and closes between the standby position and the coating position, synchronizing with a transfer of the spray coater.

(5) The spray coating device (A), wherein an upper plate of the body of the coating solution scatter prevention means placed on a transfer side of the spray coater to the standby position is transferred linked with the spray coater.

(6) The spray coating device (A), wherein the spray coater is a curtain spray coater.

(7) The spray coating device (A), wherein the ink absorption layer comprises at least one layer of inorganic fine particles and a porous layer including a binder.

(8) The spray coating device (A), wherein a current regulating device is installed inside the body.

(9) The spray coating device (A), wherein the monitoring device is positioned opposite the coating solution scatter prevention means and always monitors a spray condition of coating solution sprayed from the spray coater and then feeds back information of a location of abnormal coating to a coating record.

(10) The spray coating device (A), wherein the coating solution scatter prevention means is transferred from a standby position to a set position linked with a transfer of the spray coater from a standby position to a coating position.

(11) The spray coating device (A), wherein the coating solution scatter prevention means includes a collecting device to collect coating solution unused for spray coating.

(12) The spray coating device (A), wherein the coating solution scatter prevention means includes a gas supply device to supply gas to a gap between a substrate having a ink absorption layer on the backup roller and a lower plate of the body.

(13) The spray coating device (A), wherein the coating solution scatter prevention means is set on at least one of a downstream side and an upstream side of the spray coater.

(14) The spray coating device (A), wherein the spray coating device is set outside a drying process.

(15) The spray coating method (B), further comprising:

a step of monitoring a spray condition of coating solution sprayed from the spray coater by a monitoring device.

(16) The spray coating method (B), further comprising steps of: transferring the spray coater to a standby position by a transfer device before coating of coating solution on an ink absorption layer; and monitoring a spray condition of coating solution of the spray coater by the monitoring device; transferring the spray coater to a coating position applying spray coating of coating solution on an ink absorption layer; and transferring the spray coater to the standby position by the transfer device after coating finishes.

(17) The spray coating method (B), wherein an area of the opening is 100 to 700 percent relative to a spray area and a gas suction quantity of the suction device is 100 to 300 percent relative to an air supply quantity of the spray coater.

(18) The spray coating method (B), wherein a shutter which opens and closes is placed between the standby position and the coating position, synchronizing with a transfer of the spray coater.

(19) The spray coating method (B), wherein an upper plate of the body of the coating solution scatter prevention means placed on a transfer side of the spray coater to the standby position is transferred linked with the spray coater.

(20) The spray coating method (B), wherein while the spray coater is transferred to the standby position, the spray coater is spraying coating solution.

(21) The spray coating method (B), wherein the spray coater is a curtain spray coater.

(22) The spray coating method (B), wherein the ink absorption layer comprises at least one layer of inorganic fine particles and a porous layer including a binder.

(23) The spray coating method (B), wherein a current regulating device is installed inside the body.

(24) The spray coating method (B), wherein the monitoring device is positioned opposite the coating solution scatter prevention means and always monitors a spray condition of coating solution sprayed from the spray coater and then feeds back information of a location of abnormal coating to a coating record.

(25) The spray coating method (B), wherein the coating solution scatter prevention means is transferred from a standby position to a set position linked with a transfer of the spray coater from a standby position to a coating position.

(26) The spray coating method (B), wherein the coating solution scatter prevention means includes a collecting device to collect coating solution unused for spray coating.

(27) The spray coating method (B), wherein the coating solution scatter prevention means includes a gas supply device to supply gas to a gap between a substrate having a ink absorption layer on the backup roller and a lower plate of the body.

(28) The spray coating method (B), wherein the coating solution scatter prevention means is set on at least one of a downstream side and an upstream side of the spray coater.

(29) The spray coating method (B), wherein the spray coating device is set outside a drying process.

(30) The spray coating method (B), wherein a surface layer is formed by carrying out spray coating of coating solution across total width in a width direction of an ink absorption layer by using a spray coating device set at a position crossing a conveyance direction of a substrate.

In order to achieve the aforementioned objective, another preferred embodiment will be explained.

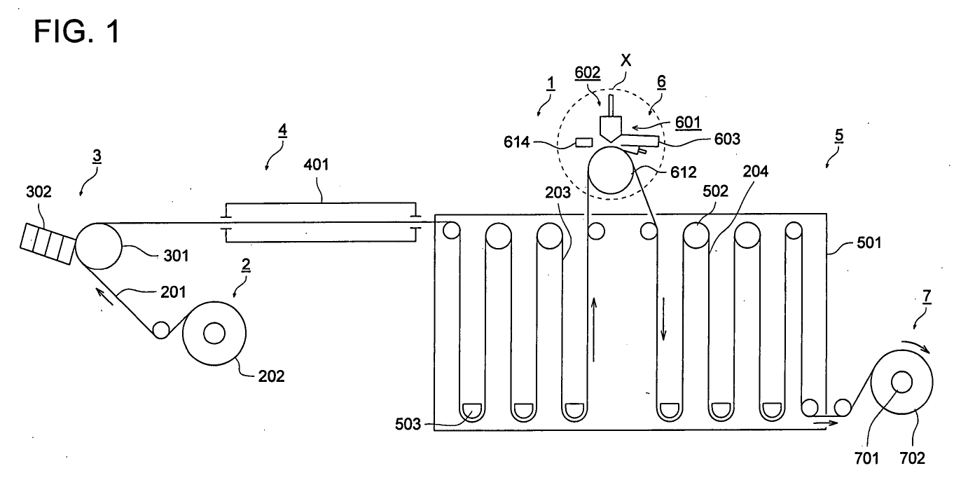

Preferred embodiments of the present invention are explained referring to FIGS. 1 to 12, however the invention is not limited to these.

FIG. 1 is a schematic diagram showing an example of a coating production line of recording sheets in which a spray coating device is installed. In FIG. 1, numeral 1 represents a coating production line. Coating production line 1 is composed of unrolling section 2 of a substrate, first coating section 3 where a coating solution for forming an ink absorption layer is coated, cooling section 4, drying section 5 and second coating section 6 where coating solution which forms a surface layer on the ink absorption layer is spray-coated, and winding section 7.

Numeral 202 represents a master roll of substrate 201. Substrate 201 unwound in unwinding section 2 is coated in first coating section 3 so as to form at least one ink absorption layer on substrate 201 wound around backup roller 301 with coater 302. It is preferable that the ink absorption layer is structured of at least one layer of inorganic particles and a porous layer including a binder. It is, further, preferable that coater 302 is a slide bead coating device of the flow regulation type because it can conduct coating of a multilayer coating solution at the same time.

Substrate 201 having a coating solution layer forming an ink absorption layer thereon is conveyed to drying section 5 in a stabilized state by cooling device 401 in cooling section 4 because the coating solution includes a hydrophilic binder, and ink absorption layer 203 is formed after removing a solvent. Numeral 501 represents a drying housing, numeral 502 represents carrying rollers and numeral 503 represents reversers which conduct non-contact reversal conveyance by blown gas so that the substrate is carried while floating so as to avoid contact of coated surface. Thereby, it is possible to dry coated surface avoiding any contact with it.

When ink absorption layer 203 has been formed after removal of the solvent in the coating solution layer in drying section 5, coating solution for the surface layer is spray-coated onto ink absorption layer 203 of the substrate wound around backup roller 612 by means of spray coating device 601 in second coating section 6 including backup roller 612 and spray coating device 601 located outside drying section 5. Spray coating device 601 is composed of spray coater 602, coating solution scatter prevention means 603 and monitoring means 614. One type of preferable spray coaters is a curtain spray coater, and thus, hereinafter, spray coater 602 represents a curtain spray coater.

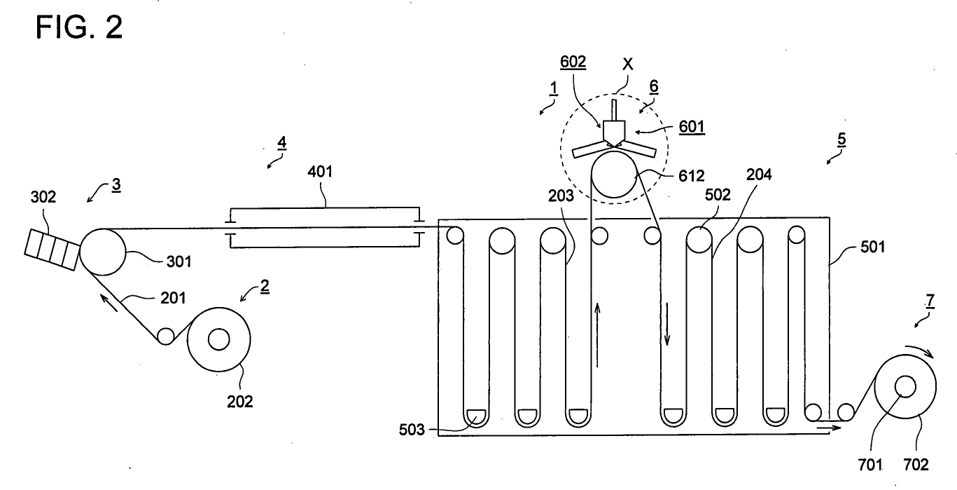

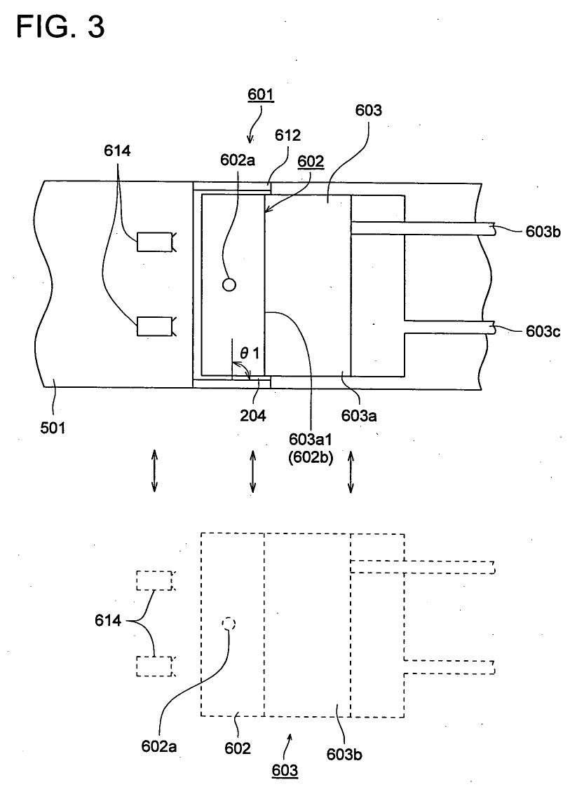

Coating solution scatter prevention means 603 may be mounted on at least one side of the downstream side and the upstream side of spray coater 602, and FIG. 1 shows the case of setting on the downstream side of spray coater 602. In FIG. 2, an example of one having two coating solution scatter prevention means on both sides is shown. Monitoring means 614 is located in a position opposed to coating solution scatter prevention means 603 sandwiching spray coater 602 whereby it is possible to always monitor the spray condition of the coating solution discharged from spray coater 602 during coating. Details of spray coating device 601 will be explained referring to FIG. 3.

The substrate coated with a coating solution for a surface layer thereon is dried again in a drying housing and surface layer 204 is formed by removal of solvents from the surface layer coating solution and discharged from the drying housing, and further, it is wound onto winding core 701 to produce a roll of recording sheet 702 in winding section 7. It is preferable to dry the coated solutions by blowing hot air (the hot air blowing means is not illustrated). In the present invention, the surface layer formed on an ink absorption layer includes a state in which a part of the coating solution has penetrated the ink absorption layer when the coating solution is spray-coated onto the ink absorption layer.

The location of second coating section 6 is not restricted only within the drying section, preferably in the downstream side of the falling-rate drying section, and re-drying after coating is possibly outside the drying section. For example the drying section of FIG. 1 is divided into a first drying section and a second drying section with second coating section 6 placed between them, and further as shown in FIG. 1 may be mounted on an upper portion of the drying housing in the drying section. In this case, placing it on an upper portion of the drying housing of the drying section is preferable because members constituting second coating section 6 can be contained without enlarging the processing facilities. Spray coater 602 of spray coating device 601 in second coating section 6 is positioned to oppose to the coating surface on a substrate and perpendicular to the conveyance of the substrate. Placing second coating section 6 outside the drying section and coating a surface layer on an ink absorption layer of the substrate supported by a backup roller brings the following desired effects.

1) Staining on carrying rollers, inner walls of the drying housing due to scattering of coating solution caused by spray coating is prevented and therefore adherence of foreign substances transferred from the carrying rollers and adhesion of fallen foreign substances from the inner walls of the drying housing can also be prevented so that product quality becomes stable.

2) Since enlargement of the drying section is not needed, loss of energy to be used for drying can be reduced to a minimum.

3) Maintenance of the spray coating device becomes easier.

4) Coating is carried out while the substrate is supported by the backup roller so that stable coating is possible without fluttering of the substrate and the product performance becomes stable.

### The First Embodiment

FIG. 3 is an enlarged schematic plan view of the portion indicated with X of FIG. 1.

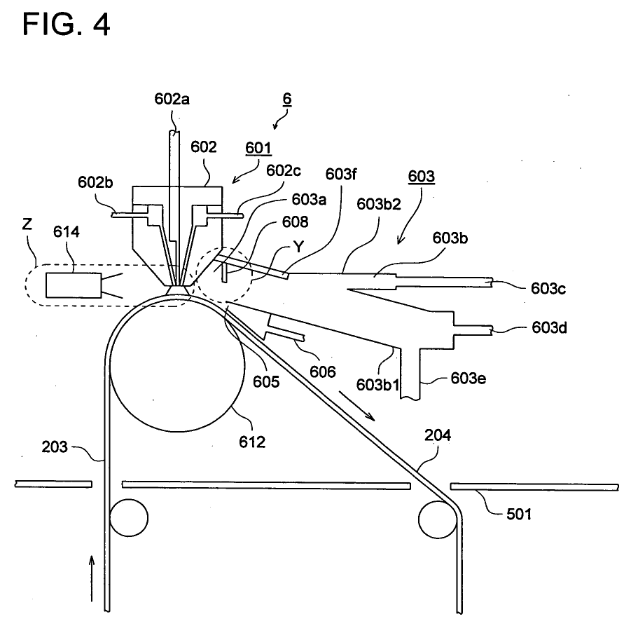

In FIG. 3, numeral 602a represents coating solution supply pipe of spray coater 602. In this figure, air supply pipes 602b and 602c (refer to FIG. 4) are omitted. Symbol 603a represents body of coating solution scatter prevention means 603 and numeral 603b (603c) represents a suction pipe as a suction means to reduce pressure inside body 603a. Other symbols have the same definition as in FIG. 1. Monitoring means 614 is located opposite coating solution scatter prevention means 603 and sandwiches spray coater 602, and further coating solution scatter prevention means 603 is located so that end 603a1 of body 603a is in contact along the full width of wall face 602b of spray coater 602.

As monitoring means 614, for example, a high speed video camera (Photron Limited) and a CCD camera (Elmo Co., Ltd.) are applicable. Monitoring camera 614 needs to monitor the whole width of spray coater 602 so that the number of the monitoring means 614 can be changed according to the performance of monitoring means 614 and the size of spray coater 602. FIG. 3 shows the case that two monitoring means 614 are stationed so as to monitor the two areas divided in the middle.

Monitoring means 614 is preferably configured to operate all the time from setting of the spraying condition till the coating termination. When any abnormalities occur during spraying, a controller (not illustrated) controls so as to notify the time and location of the abnormality because the information from monitoring means 614 is timed from the start of coating. After termination of coating, it is possible to confirm whether there were any abnormalities by checking spray condition from the starting time to termination from the controller (not illustrated).

It is preferable that spray coater 602 is transferred from the stand-by position (the position of spray coater shown with broken lines) to the coating position with transfer means (not illustrated) when coating starts. It is also preferable that coating solution scatter prevention means 603 is transferred from the stand-by position (the position of coating solution scatter prevention means 603 shown with broken lines) to the coating position of spray coater 602 with a transfer means (not illustrated) the same as spray coater 602 when coating starts. Monitoring means 614 is also preferably transferred from the stand-by position (the position of monitoring means shown with broken lines) to the coating position of spray coater 602 with a transfer means (not illustrated) when coating starts. Spray coater 602, coating solution scatter prevention means 603 and monitoring means 614 can be transferred individually or all of them can be transferred together.

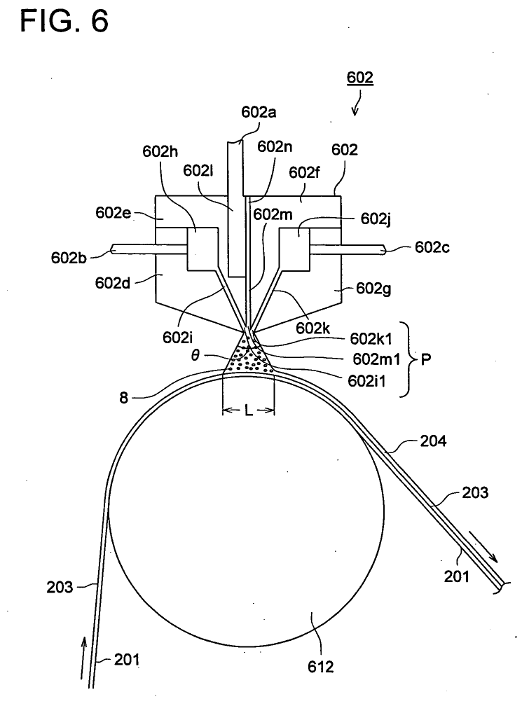

Symbol θ1 represents an angle at which spray coater 602 and substrate 201 (refer to FIG. 1) cross. In the present invention, the lines formed by spray outlet P (refer to FIG. 6) is parallel to the substrate and crosses the conveyance direction of the substrate at the angle. That is, the spray coater is positioned to cross the conveyance direction of the substrate (the arrowed direction in FIGS. 1 and 4). Angle θ1 is preferably 70 to 110° in consideration of the area to be coated and ease of setting of the coating solution spray condition. In FIG. 3, the case is shown where the crossing angle between spray coater 602 and the substrate is 90°.

It is preferable that spray outlet P (refer to FIG. 6) of spray coater 602 is at least of a distance corresponding to the coating width (the length of area being coated on a belt-shaped substrate in the direction crossing the conveyance direction of the belt-shaped substrate) of ink absorption layer 203 (refer to FIG. 4) on a belt-shaped substrate. With such positioning, coating of a thin coating layer with a small drying load and highly uniform layer thickness becomes possible by conveying the belt-shape substrate against spray coater 602 and spraying a coating solution across the coating width of ink absorption layer 203 on the belt-shape substrate.

FIG. 4 is an enlarged schematic diagram of the position shown by X in FIG. 1.

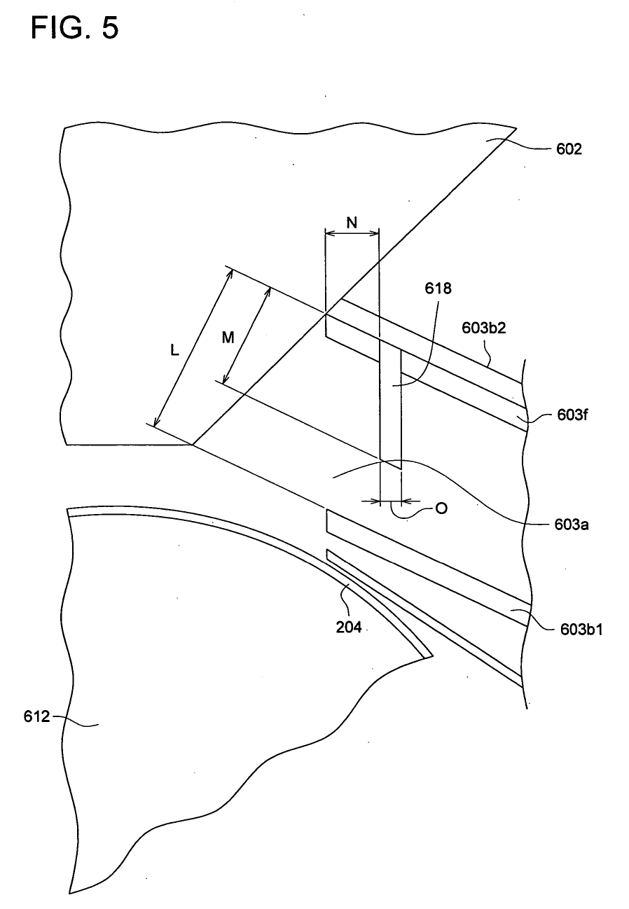

In FIG. 4, symbols 602b and 602c represent air supply pipes. Coating solution scatter prevention means 603 includes box-structured body 603b having opening 603a on the side of spray coater 602, suction pipes 603c and 603d as suction means to reduce pressure inside body 603b, coating solution collecting pipe 603e as a collecting means for unused coating solution collected in body 603b and gas supply means 606 to supply gas to gap 605 between substrate 201 (refer to FIG. 1) having ink absorption layer 203 on backup roller 612 and lower surface 603b1 of body 603b. Numeral 618 represents current plate (current regulating plate) mounted on the inside of upper plate 603b2 of body 603b as a current regulating means which regulates the air current from opening 603a and facilitates collection of unused sprayed coating solution when the pressure in body 603b is reduced by suction through suction pipes 603c and 603d. Current plate 618 will be explained referring to FIG. 5.

The material structuring coating solution scatter prevention means 603 is not limited only if it is durable against solvents used in the coating solution and, acrylic resin, stainless steel and aluminum are applicable examples. Further, the material of the current plate as a current regulating means is also not limited only if it is durable against solvents used in the coating solution and, the same material used in coating solution scatter prevention means 603 is also applicable.

The area of opening 603a is 100 to 700% of the spray area to be sprayed with a coating solution. The area of opening 603a is smaller than 100% of the spray area is not preferable because the gas current speed becomes faster than its needed speed at the time of suction and causes turbulent air flow between the spray coater and the substrate, resulting in non-uniform spraying which causes non-uniform coating. Further, it is also not preferable because due to the gas turbulent flow, some coating solution droplets are scattered before they reach the substrate and it causes non-uniform spraying, non-uniform coating, reduction of coating amount onto the substrate and reduction of the coating yield. The area of opening 603a being larger than 700% of the spray area is also not preferable because it causes fluttering of the substrate and leading to non-uniformity of spraying resulting in non-uniform coating because the suction force of gas suction pressure needs to be larger than the tension force of the substrate pressing on the backup roller. It is, further, not preferable because due to the high suction pressure, some droplets of coating solution are sucked away before they reach the substrate causing, reduction of coating amount deposited on the substrate and reduction of the coating yield.

The coating yield is calculated from measured concentration/theoretical concentration×100. The concentration was measured at 10 points across the width at 10 meter intervals on a sample substrate from the beginning to the end of the coating process and an average value was obtained from all the measured values. The theoretical concentration is obtained from a calibration curve showing the relationship between coated layer thickness and concentration.

In the present invention, the area of opening 603a is determined by addition of the area obtained by multiplying length L of opening 603a (refer to FIG. 5) by the length of the longer side of the spray coater and an area obtained by multiplying the height of the gap between the spray coater and the substrate by the longitudinal length of the gap.

The spray area is the area on the substrate to be reached by the coating solution sprayed from spray outlet P (refer to FIG. 6).

As the supply quantity of gas from gas supply means 606, 1.5 m³/min to 4 m³/min is preferable for example when the reduced pressure inside body 603b is −3.4 KPa. When the supply quantity is less than 3 m³/min and if the supply amount of coating solution is large, non-uniform coating may occur because all the sprayed droplets can not be sucked away only by the suction force inside the cover and sprayed droplets leak through the gap between the substrate and the cover. Further, droplets which adhere to the inner surfaces of body 603b condense and drop onto the substrate to make non-uniform concentration. When the supply amount of gas exceeds 6 m³/min, excessive force is given to coating solution sprayed from the nozzles and cause non-uniform spraying of the coating solution resulting in non-uniform concentration.

Suction pipes 603c and 603d are connected to a vacuum pump (not illustrated) whereby the pressure in body 603 can be reduced. Coating solution collecting pipe 603e is connected to a collecting tank (also not illustrated). The gas suction amount of suction pipes 603c and 603d is 100 to 300% of the air supply amount. If it is less than 100% of the air supply amount, droplets of coating solution in the spray state, which are not sucked up by the coating solution scatter prevention means, cause adhesion to the substrate resulting in non-uniform coating. Alternatively, if it exceeds 300% of the air supply amount, droplets of coating solution in the spray state are sucked up by the coating solution scatter prevention means more than the needed quantity and the adhesion ratio on the substrate is reduced, resulting in low coating yield.

The pressure reduction degree in body 603b is preferably −2 to −6 KPa. When the pressure reduction degree is less than −2 KPa, droplets of coating solution in the spray state which are not coated on the ink absorption layer are scattered without being collected and may cause delayed adhesion on the ink absorption layer resulting in non-uniform coating or may stain adjacent surfaces. When the pressure reduction degree exceeds −6 Kpa, a majority of sprayed droplets may be collected whereby the coating ratio may be reduced to a degree to cause coating defects. Further, the substrate being conveyed is caused to flutter resulting in mis-feeding and contact of the substrate with the coating solution scatter prevention means, causing further defects.

Because of suction through suction pipes 603c and 603d, sprayed coating solution in the spray state, which was not applied as coating, adheres to inside surfaces of body 603b to become drops without scattering and are collected in a collecting tank (not illustrated) through coating solution collecting pipe 603e. Symbol 603f represents an absorbing member positioned in the vicinity of opening 603a inside of body 603b.

As an adsorption member, the following high polymer absorbent materials (Superabsorbent Polymer: SAP) are cited, for example: graft polymer of starch system, carboxyl methylated substances, graft polymers of the cellulose type and carboxylmethylated substances; simple substances or synthetic substances of each of polyacrylic acid systems such as synthetic polymers, polyacrylate systems, polyvinyl-alcohol systems, polyacrylamide systems, polyoxyethylene systems, and isobutylene maleate systems; or mixture of each of starch systems as well as cellulose type and synthetic polymer systems. In the case of using a sodium-polyacrylate system resin as an example, after absorbing moisture, sodium ions are discharged through the mesh of a net of a polymer, water flows through the clearance of the polymer mesh of the net which becomes larger by the electronic repulsion between the carboxylate ions of a polymer side chain, whereby an absorption effect arises. Moreover, as other water absorbent carriers, it is also possible, for example, to use a various super-absorbent polymers which are described in the journal “The Surface, Vol. 33, No. 4, 52-59 (1995)” and which are used for personal sanitary materials, such as disposable diapers and other sanitary items, agricultural garden supplies, such as soil water retention material, etc.

Absorption member 603f prevents droplets of coating solution adhering to the inner surface of opening 603a from dropping on ink absorption layer 203 of a substrate onto backup roller 612.

FIG. 5 is an enlarged diagram of portion Y in FIG. 4.

In FIG. 5, symbol L represents the height of opening 603a. It is preferable that the area of the opening is appropriately selected to be 100 to 700% of the spray area. Symbol M represents the length of current plate 618. Length M is preferably 50 to 80% of length L of opening 603a in consideration of the spray speed of the coating solution, degree of pressure reduction in the coating solution scatter prevention means and strength of the current plate.

Symbol N represents the distance between the edge of upper portion 603b2 of body 603b of the coating solution scatter prevention means and the installation position of the current plate. Distance N is preferably 5 to 30 mm from the edge of upper portion 603b2 of body 603b in consideration of the adhesion of droplets of the coating solution onto the current plate due to rebound of the droplets onto the substrate, non-uniform coating due to fallen drops of adhering droplets to the current plate onto the ink absorption layer and gas flow between the spray coater and the current plate.

Symbol O represents the thickness of current plate 618, which is preferably 3 to 20 mm in consideration of deflection of the current plate depending on the degree of pressure reduction in the coating solution scatter prevention means, stability of the gas flow due to the deflection of the current plate, flow speed of the gas flowing through the gap between the current plate and the lower surface of the body, suction of the droplets of the coating solution reaching the ink absorption layer on the substrate, and the coating yield.

By installing current plate 618 as shown in FIG. 5, the following effects can be obtained.

1) Because suction of the sprayed coating solution prior to adhesion onto the substrate can be prevented and coating onto the substrate without reducing the coating yield is possible, stable coated products can be obtained.

2) Dynamic pressure in the coating solution scatter prevention means can be reduced and uniform gas flow across the width of a substrate can be secured and therefore coating uniformity across the width can be ensured to obtain stable coated products.

3) Because the flow speed around the current plate can be locally increased and turbulent flow generated between the spray coater and the coating solution scatter prevention means can be restrained, coating uniformity due to reduced air turbulence can be ensured to obtain stable coated products.

FIG. 6 is an enlarged schematic diagram showing an aspect of the coating condition of the spray coater shown in FIG. 1. In FIG. 6, the coating solution scatter prevention means mounted downstream of the spray coater is omitted.

In FIG. 6, Symbol 602a represents a coating solution supply pipe to supply coating solution to spray coater 602 and symbols 602b and 602c represent paired pressurized air supply pipes to spray the coating solution to form a surface layer, which is supplied to spray coater 602 to conduct spray coating onto ink absorption layer 203 of belt-shaped substrate 201 continuously conveyed (the arrowed direction in FIG. 6).

Numeral 204 represents the surface layer formed on ink absorption layer 203 on belt-shape substrate 201. Belt-shaped substrate 201 is transferred (conveyed) relative to the coating solution discharge section of spray coater 602 whereby the coating process is successively carried out. Spray outlet P of spray coater 602 for coating solution is at least of the length corresponding to the coating width (being the length of area coated on the belt-shaped substrate in the direction crossing the conveyance direction of the belt-shaped substrate) of belt-shaped substrate 201 and is preferably located to cross the conveyance direction of belt-shaped substrate 201 (refer to FIG. 3). With such positioning, belt-shaped substrate is conveyed against spray coater 602 and by spraying coating solution droplets across the coating width onto the belt-shaped substrate, a thin coated layer with small drying load and high uniformity of layer thickness can be created.

Symbols 602d to 602g represent each block structuring spray coater 602. Symbol 602h represents a pressurized air pocket structured of blocks 602d and 602e, symbol 602i represents an air nozzle formed within blocks 602d and 602e, and symbol 602j represents a pressurized air pocket structured of blocks 602f and 602g, and symbol 602k represents an air nozzle structured of blocks 602f and 602g.

Pressurized air supplied from a pressurized air supply source (not illustrated) through each pressurized air supply pipe 602b or 602c is temporarily stored in each pressurized air pocket 602h or 602j and discharged from each opening end 602i1 or 602k1 through each air nozzle 602i or 602k.

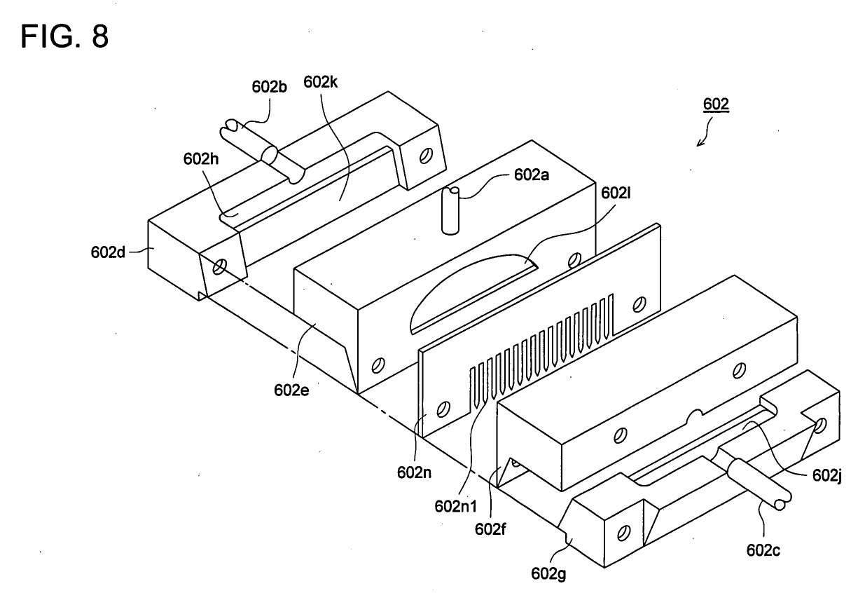

Symbol 602l represents a coating solution pocket structured of block 602e and block 602f to temporarily store coating solution supplied from the coating solution supply pipe. Symbol 602m represents a nozzle for coating solution formed of comb-shaped member 602n sandwiched between blocks 602e and 602f. Coating solution stored in coating solution pocket 602l is discharged from opening end 602m1 of coating solution nozzle 602m, and at the same time, is sprayed into the spray state with pressurized air jetted from opening end 602i1 or 602k1 of each air nozzle 602i or 602k so that it is coated on ink absorption layer 203 of belt-shaped substrate 201. Further, a distance can be appropriately selected in the range of approximately 2 to 50 mm between the ink absorption layer and spray outlet P, which is structured of opening ends 602i1 and 602k1 of respective air nozzles 602i and 602k of spray coater 602 and opening end 602m1 of nozzles for coating solution 602m. Numeral 8 represents coating solution converted into the spray state. Comb-shaped member 602n will be explained referring to FIG. 8.

It is preferable that the area to be spray-coated with coating solution on ink absorption layer 203 is always the same and especially preferable is a uniform diameter distribution of droplets, uniform length L in the conveyance direction across the coating width and uniform spread angle θ of sprayed droplet pattern via spray outlet P being the base point, toward the belt-shaped substrate, across the coating width. Further, the collision speed of the droplets onto ink absorption layer 203 is preferably uniform. By the above, it becomes possible to maintain high uniformity of the coated layer thickness. “Uniform diameter distribution of droplets across the coating width” specifically means the variation of average diameter of the droplets is less than ±20 percent, but preferably less than ±10 percent.

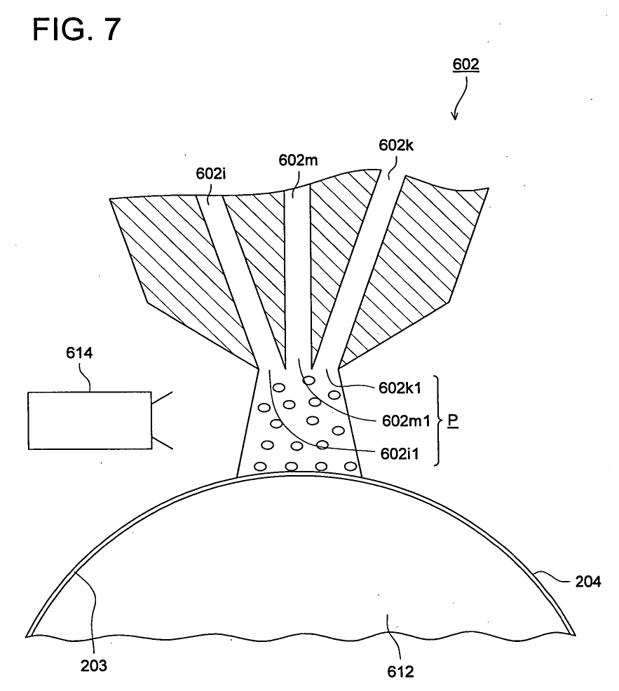

FIG. 7 is an enlarged schematic diagram of portions indicated by area Z in FIG. 4.

Symbols in FIG. 7 have the same definition as in FIG. 4 or FIG. 6. As a monitoring means 614, an example in which a high speed video camera (Photron Limited) is employed is shown in FIG. 7. With monitoring means 614, monitored are the size of droplets 8 of the coating solution sprayed into the spray state from spray outlet P structured of opening ends 602i1, 602k1 and 602n1 of spray coater 602. Whereby also monitored is the distribution of the size of droplets 8, density of droplets 8 across the width of spray coater 602 and through the height of sprayed coating solution. The information from monitoring means 614 is inputted to a CPU of a control means (not illustrated) and is processed with information related to setting conditions (the size of droplets 8 of the coating solution, size distribution of droplets 8, density of droplets 8 and the like, corresponding to coating speed for each coating solution as well as coated layer thickness during coating) previously inputted in a memory, and further, different information from the previously stored information in the memory is recorded as information of abnormality.

By monitoring the condition of the coating solution spray emitted from spray coater 602 with monitoring means 614 related to the present invention, the following effects can be obtained.

1) Because coating solution spray condition can be adjusted with the monitoring means of the spray coater without actually observing the condition of coated coating solution on the substrate, waste of the substrate and coating solution can be reduced.

2) Any change of the spray condition can be immediately noticed due to any difference of physical property of the coating solution caused from change of a batch, whereby waste of the coating solution and the substrate can be reduced to the utmost.

3) Even when clogging occurs in the spray coater due to small foreign substances mingled in coating solution or in the supplied air, abnormality can be immediately noticed, and waste of the coating solution and/or the substrate can be reduced to the utmost.

4) With full-time monitoring of the spray condition, the place where any abnormality of the spray condition occurred becomes apparent and easy elimination at the coating defect point becomes possible to improve productivity.

FIG. 8 is an exploded schematic perspective diagram of the spray coater (being a curtain spray coater) shown in FIGS. 1 to 7.

In FIG. 8, symbols 602e and 602f represent blocks which form the nozzles for coating solution 602m having a prescribed distance (refer to FIG. 6) to allow coating solution to flow down to the nozzle. Block 602e receives coating solution supplied from a coating solution supply source which is not illustrated and has coating solution supply pipe 602a communicating with coating solution pocket 602l. Coating solution stored in coating solution pocket 602l flows down through the nozzle for coating solution, formed between blocks 602e and 602f. Symbol 602n represents a comb-shaped sandwiched with block 602e and block 602f, and forms plural nozzles for coating solution extending across coating width by dividing the slit between blocks 602e and 602f. Symbol 601n1 represents comb teeth.

Block 602d in conjunction with block 602e forms air nozzle 602i to supply air to the end of coating solution nozzle 602m (refer to FIG. 6). Block 602g in conjunction with block 602f forms air nozzle 602k (refer to FIG. 6) to supply air to the end of coating solution nozzle 602m (refer to FIG. 6). Air nozzle 602i and air nozzle 602k are formed across the coating width.

Compressed air is supplied from an air supply source (not illustrated) into pressurized air supply pipe 602b (602c), and after temporary storage in pressurized air pocket 602h (602j), it flows down through air nozzle 602i (602k) under high pressure.

Coating solution, which flows down through coating solution nozzle 602m (refer to FIG. 6) structured of comb-shaped member 602n and compressed air, which flows down two air nozzles 602i (602k) collide at jetting outlet P (refer to FIG. 6) to create droplets which are sprayed onto the substrate to be coated.

Regarding the spray coater (being a curtain spray coater) utilized in the present invention, the gap width of coating solution nozzle 602m (refer to FIG. 6) is preferably in the range of 50 to 300 μm. The shape of the opening end of coating solution nozzle 602m (again refer to FIG. 6) can be a single slit extending across the coating width, or can be distinct round or rectangular orifices incorporating a comb-shaped member as shown in FIG. 8. The shape of opening end can be changed according to the structure of the comb member. When the shape of the opening end is round or rectangular, the opening end can be employed within the gap width of nozzle for coating solution 602m and the pitch (distance) is preferably 100 to 3000 μm (corresponding to the distance of teeth 602n1 of comb-shaped member 602n).

On the other hand, the gap width of air nozzle 602i (602k) (refer to FIG. 6) is preferably 50 to 500 μm. As to the opening end of air nozzle 602i (602k) (refer to FIG. 6), it can be a single slit extending across the coating width, or distinct round or rectangular orifices incorporating comb-shaped member incorporating as shown in FIG. 8. The shape of opening end can be changed according to the structure of the comb member. When the shape of the opening end is round or rectangular, an opening end can be employed within the gap width of air nozzle 602i (602k) (refer to FIG. 6) and the pitch (distance) is preferably 100 to 3000 μm (corresponding to the distance between teeth 602n1 of comb-shaped member 602n).

The angle of the air nozzles against the nozzle for coating solution is preferably in the range of 5 to 50 deg. The supply amount of coating solution from the coating solution nozzle is not necessarily specified because it depends on desired coated layer thickness, concentration of the coating solution and coating speed, broadly however a quantity of 1 to 50 g/m² is preferable as the coating amount on a substrate to form a stable uniform coated layer in consideration of drying load. The wet layer thickness is preferably 1 to 50 μm and more preferably 5 to 30 μm.

Gas jetted from the air nozzle is not specifically restricted only if it is suitable for the coating and generally air is employed. The supplied gas is typically in the range of 1 to 50 CMM/m (flow rate per coating width) and the internal pressure of the gas nozzle is preferably higher than 10 kPa in view of uniformity of coating.

Linear velocity “v” of air is preferably 126 to 400 m/s in view of coating solution drying characteristics and the coating yield. Linear velocity “v” of air is the air linear velocity at the outlet of the air nozzle and can be measured with a Doppler anemometer for example 1D FLV system 8851, a product of Kanomax USA, Inc. Coating yield values can be determined by either of the following two methods. 1) It is calculated via “quantity of coating solution coated on the ink absorption layer/total supplied coating solution×100 (%)”. That is, quantity of the coating solution coated on the ink absorption layer is calculated from the variation of mass between before and after coating on the ink absorption layer, and the total supplied coating solution is obtained from mass of coating solution fed and supplied, namely the fed quantity/coating time. 2) In the case of a colored coating solution, theoretical concentration is previously acquired from experimentation from the relationship between coating layer thickness, and the concentration, and measured concentration/theoretical concentration×100 is calculated.

### The Second Embodiment

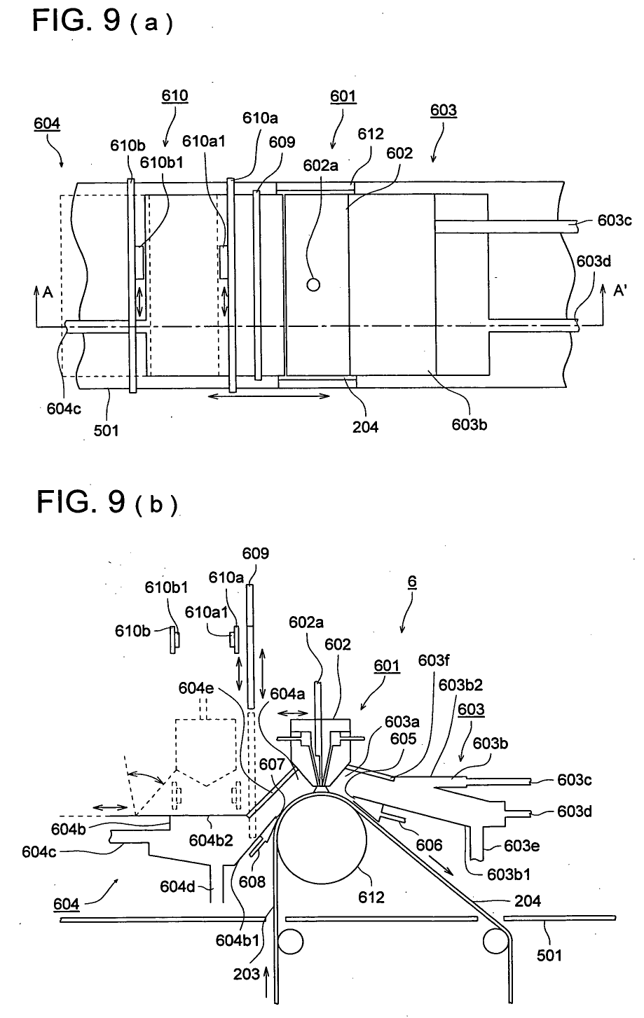

FIG. 9 is an enlarged schematic diagram of the portion indicated by symbol X in FIG. 2. FIG. 9(a) an enlarged schematic plan view of the portion indicated by symbol X in FIG. 2. FIG. 9 (b) is a schematic cross sectional view of A-A′ section in FIG. 9(a).

In FIG. 9, numeral 601 represents a spray coating device. Spray coating device 601 is composed of curtain spray coater 602 which is preferable for coating of surface coating of recording sheets related to the present invention, coating solution scatter prevention means 603 mounted on the downstream side of curtain spray coater 602, coating solution scatter prevention means 604 mounted on the upstream side of curtain spray coater 602. Spray coating device 601 is further composed of shutter 609 which blocks between the coating position (the position of curtain spray coater shown by solid lines) and the standby position (the position shown by broken lines) when curtain spray coater 602 is shifted to the standby position (the position shown by broken lines) by transfer means (not illustrated) and monitoring mechanism 610 to monitor the spraying condition of curtain spray coater 602 when curtain spray coater 602 is shifted to the standby position.

Symbol 602a represents coating solution supply pipe of curtain spray coater 602. Coating solution scatter prevention means 603 includes body 603b of box structure having opening 603a on the side of curtain spray coater 602, suction pipe 603c as a suction means to reduce pressure inside body 603b, suction pipe 603d, coating spray collecting pipe 603e as a collecting means for unused coating solution collected in body 603b. Coating solution scatter prevention means 603 further includes gas supply means 606 supplying gas to gap 605 between substrate 201 (refer to FIG. 2) having ink absorption layer 203 on backup roller 602 and lower plate 603b1 of body 603b.

As the supply quantity of gas from gas supply means 606, 3 m³/min to 6 m³/min is preferable for example when the reduced pressure inside body 603b is −3 KPa. When the supply quantity is less than 3 m³/min and if the supply amount of coating solution is large, non-uniform coating may occur because all the sprayed droplets cannot be sucked by only suction force inside the cover and droplets in the spray state leak through a gap between the substrate and the cover. Further, there are cases that droplets which adhere to an inner surface of body 603b is condensed and drops of it fall onto the substrate to make non-uniformity of concentration. When the supply amount of gas exceeds 6 m³/min, excessive resistance is given to coating solution sprayed from a nozzle and cause non-uniform spray condition of coating solution resulting in non-uniform concentration.

Suction pipes 603c and 603d are connected to a vacuum pump (not illustrated), which enable the pressure to be reduced inside body 603b. Coating solution collecting pipe 603e is connected to collecting tank (not illustrated). The pressure reduction degree in body 603b is preferably −2 to −6 KPa. When the pressure reduction degree is less than −2 KPa, droplets of coating solution in the spray state which have not been coated on the ink absorption layer are scattered without being collected and it may cause delayed adhesion on the ink absorption layer resulting in non-uniformity of coating or may stain the surroundings. When the pressure reduction degree exceeds −6 KPa, a majority of sprayed droplets may be collected and the coating ratio may reduce to cause coating defects. Further, the substrate being conveyed causes fluttering resulting in mis-feeding and contact of the substrate with the coating solution scatter prevention means and it makes defects.

Because of suction through suction pipes 603c and 603d, sprayed coating solution in the spray state, which was not related to the coating, adheres to the inside of body 603b to become drops without scattering and is collected into a collecting tank (not illustrated) through coating solution collecting pipe 603e. Symbol 603f represents an absorbing member pasted in the vicinity of opening 603a in the inside of body 603b.

The materials of the absorption member are the same as in the first embodiment.

Absorption member 603f prevents droplets of coating solution adhering to the inner surface of opening 603a from dropping on ink absorption layer 203 of a substrate on backup roller 612.

Coating solution scatter prevention means 604 includes box-structured body 604b having opening 604a on the side of spray coater 602, suction pipes 604c as suction means to reduce pressure inside body 604b, coating solution collecting pipe 604d as a collecting means for unused coating solution collected in body 604b and gas supply means 608 to supply gas to gap 607 between substrate 201 having ink absorption layer 203 on backup roller 602 and lower surface 604b1 of body 604b. Gas supply amount from gas supply means 608 is preferably the same as from gas supply means 606.

Suction pipe 604c is connected to a vacuum pump (not illustrated), which enable the pressure to be reduced inside body 604b. Coating solution collecting pipe 604d is connected to a collecting tank (not illustrated). Pressure reduction degree inside body 604b is preferably the same as in body 603b of coating solution scatter prevention means 603. By suction of suction pipe 604c, sprayed coating solution in the spray state which was not related to coating adheres to the inside of body 604 without scattering to become drops and is collected to a collecting tank (not illustrated) through coating solution collecting pipe 604d. Symbol 604e represents an absorption member pasted inside body 604b near opening 604a. The absorption member is the same as one used for coating solution scatter prevention means 603. With absorption member 604e, prevention becomes possible, of drops of coating solution adhering to an inner surface of opening 604a from falling onto ink absorption layer 204 of the substrate on backup roller 602.

Curtain spray coater 602 is mounted on a frame (not illustrated) so that it can travel from the standby position (the position of the spray coater shown by broken lines) to the coating position (the position of spray coater shown by solid lines) at the beginning of a coating process with a transfer means (not illustrated). Backup roller 602 is also supported at the axis rotatably (to the arrow direction in FIG. 9) on the frame (not illustrated). Upper plate 604b2 of body 604b of coating solution scatter prevention means 604 can be transferred (in the arrow direction in FIG. 9), and can be opened and closed (in the arrow direction in FIG. 9) in conjunction with travel of curtain spray coater 602.

Shutter 609 is installed on a frame of spray coating device 601 (not illustrated) such that it blocks between the coating position (the position of the spray coater shown by solid lines) and the standby position (the position of the spray coater shown by broken lines) when spray coater shifts to standby position (the position of the spray coater shown by broken lines) with traveling means and further such that it moves synchronizing with the travel of curtain spray coater 602 (in the arrow direction in FIG. 9)

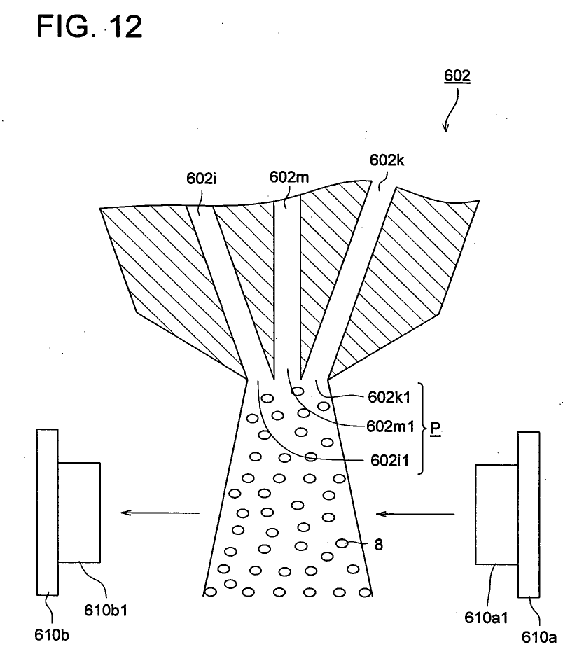

Numeral 610 represents monitoring mechanism to monitor to check whether the coating solution spray condition of curtain spray coater meets the prescribed set condition, when spray coater 601 is shifted to the standby position. Monitoring mechanism 610 includes guide rail 610a for traveling of monitoring means 610a1 and guide rail 610b for traveling of monitoring means 610b1. The guide rails have been mounted parallel to each other in the width direction of curtain spray coater 602 on the frame of spray coating device 6 (not illustrated). When curtain spray coater 602 is shifted to the standby position, the guide rails are lowered to the position to monitor the spray condition of coating solution (the position shown by broken line in FIG. 9). Monitoring method of spray condition of curtain spray coater 602 by monitoring mechanism 610 will be explained referring to FIG. 12. The monitoring means can monitor a spray condition of curtain spray coater 602 by traveling in the width direction of curtain spray coater 602 along the guide rails (the arrow direction in FIG. 9) and by hoisting of the guide rails.

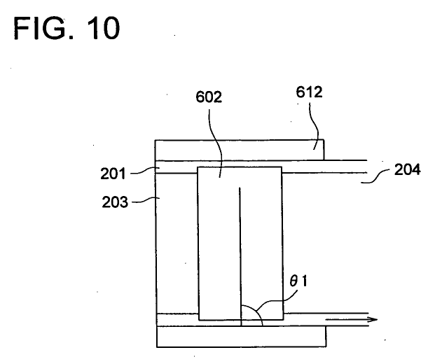

FIG. 10 is a schematic diagram showing the location of spray coating device shown in FIG. 9 against a substrate. In FIG. 10, the illustration of coating solution scatter prevention means is omitted.

In FIG. 10, Symbol θ1 represents an angle at which curtain spray coater 602 and substrate 201 cross each other. In the present invention, the lines formed by spray outlet P curtain spray coater 60 of spray coating device (refer to FIG. 12) is parallel with the substrate and it crosses the conveyance direction of the substrate at the angle. That is, the spray coater is positioned in the position crossing the conveyance direction of the substrate (the arrow direction in FIG. 10). Angle θ1 is preferably 70 to 110° in consideration of the area to be coated and easiness of setting of the coating solution spray condition. In FIG. 10, the case is shown where the crossing angle between spray coater 603 and the substrate is 90°. When angle θ1 is less than 70°, coating area becomes wider and there are cases when setting of spray condition becomes difficult. When angle θ1 exceeds 110°, the situation is the same as when angle θ1 is less than 70°.

Spray outlet P (refer to FIG. 12) of curtain spray coater 602 preferably has at least length corresponding to coating width of ink absorption layer 203 on a belt-shaped substrate (the length of area to be coated on the belt-shaped substrate in the direction crossing the conveyance direction of the belt-shaped substrate). By positioning like this, the belt-shaped substrate is moved against the curtain spray coater and by spraying coating solution to ink absorption layer 203 on a belt-shaped substrate across the coating width, a thin coated layer with small drying load and with layer thickness uniformity becomes possible.

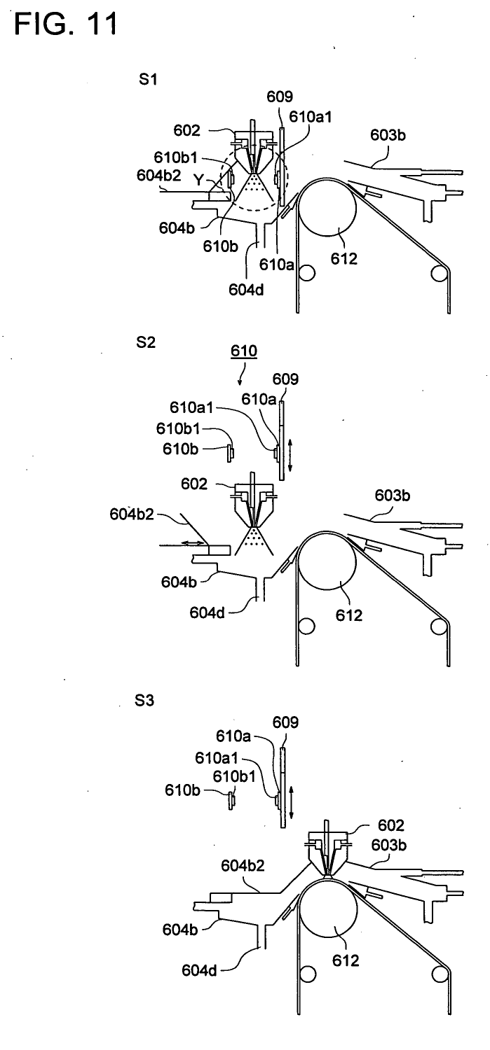

FIG. 11 is a schematic flowchart showing movement of the spray coater, the monitoring mechanism and the shutter before starting of coating till the coating start of the spray coating device shown in FIG. 2.

In S1, curtain spray coater 602 is at the standby position and spray condition is monitored by the monitoring mechanism. When the condition is deviated from the set condition, adjustment is applied. Paired of guide rails 610a1 (610b1) and paired of monitoring means 610a1 (610b1) are lowered to the position where they can monitor spray condition of spray coater 610a. Based on the information from monitoring means 610a1 (610b1), supply amount of coating solution to curtain spray coater 602 and air quantity are adjusted by a control means (not illustrated). The details of the monitoring will be explained referring to FIG. 12.

In S2, after spray condition of coating solution of curtain spray coater 602 is adjusted based on information from monitoring means 610a1 (610b1), upper plate 604b2 of body 604b of coating solution scatter prevention means 604 is opened and shutter 609 and monitoring mechanism 610 is lifted.

In S3, upper plate 604b2 of body 604b of coating solution scatter prevention means 604 is closed and curtain spray coater 602 is shifted to the coating position. Simultaneously the upper plate 604b2 is shifted to set on body 604b so that the interior of body 604b can be decompressed.

FIG. 12 is an enlarged diagram of the portion indicated by symbol Y in S1 of FIG. 11.

Symbols in FIG. 12 have the same meaning as FIGS. 6 and 11. Each type of devices on the market can be used for monitoring means 610a1 (610b1). For example, laser analysis type particle size distribution (Malvern Instrument Ltd), a high speed video camera (Photron Limited) can be cited. In FIG. 12, an example when laser is employed is shown and monitoring means 610a1 is a laser emitting portion and monitoring means 610b1 is a laser receiving portion. Monitoring means 610a1 (610b1) is mounted on guide rails movably. Guide rails 610a (610b) are positioned to vertically travel parallel to the axis of curtain spray coater 602 (the arrow direction in FIG. 12). Monitoring means 610a1 (610b1) monitors size of droplets 8 of coating solution, size distribution of droplets 8 and density of droplets 8 sprayed in the spray state from spray outlet P composed of opening ends 602l1, 602k and 602m1 of curtain spray coater 602 in the width direction of spray coater 602 and the height direction of sprayed coating solution. The information from monitoring means 610a1 (610b1) is inputted in a CPU of control means (not illustrated) and is processed with information related to setting condition (the size of droplets 8 of coating solution, size distribution of droplets 8, density of droplets 8, corresponding to coating speed for each coating solution to be used and coated layer thickness during coating) previously inputted in a memory, and further, to meet the information previously stored in the memory, the supply amount of coating solution to curtain spray coater 602 and air quantity are adjusted.

An example is shown of conditions of the monitoring method of coating solution for a surface layer in the spray state using curtain spray coater 602 and a laser beam. Coating solution for a surface layer composed of the following materials is prepared.

| | |
|---|---|
| Dispersions-1 | 99 ml |
| Organic particle emulsion-1 | 250 ml |
| Modacrylic emulsion | 11 ml |
| Water | 575 ml |

Viscosity was 1.74 mPa·s at 40° C. (measured with B type viscometer)

As dispersions-1, 100 g of 15% water solution of cationic polymer (P1) was added with 500 g of 25% water dispersion of fine particle silica (QS-20, manufactured by Tokuyama Corp) having an average primary particle diameter of 12 nm, followed by 3.0 g of boric acid and 0.7 g of pyroborate, and then the resulting mixture was dispersed employing a high-speed homogenizer.

Organic particle emulsion-1 was prepared by carrying out emulsion polymerization using the monomer of n-butyl acrylate: styrene: 2-hydroxyethyl methacrylate:t-butyl methacrylate=10:50:20:20 (mass ratio). Stearyl trimethyl ammonium chloride was used for the activator. A glass transition point (Tg) is 76° C., and the particle diameter of the emulsion obtained by the laser scattering-about method is 30 micrometers.

As modacrylic emulsion, used was a modacrylic emulsion of −30° C. glass transition point, produced by Daiichi Kougyou Co., Ltd, having 30 micrometer diameter particles with non-ionic detergent.

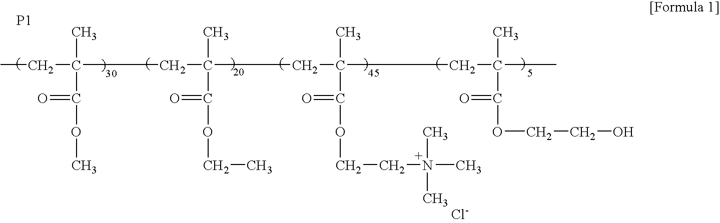

Monitoring Condition

The spray condition of curtain spray coater which had been set such that width of the ink absorption was 1540 mm, conveyance speed of substrate was 300 m/min, wet layer thickness of coating solution was 50 μm and layer thickness dispersion was ±5 μm, was monitored with laser analysis type particle size distribution measuring device (Malvern Instrument Ltd). As a result, it was confirmed that the size of droplets of coating solution, the droplet size distribution and the density of droplets are deviated from the initial setting value. By applying adjustment of air pressure at an air nozzle of the curtain spray coater and coating solution supply amount, the pressure from air nozzle was corrected to 0.4 MPa and coating solution supply amount was corrected to 3 L/min to set droplet size of coating solution and, the droplet size distribution and the density of droplets are reset to the initial setting value.

As shown in FIG. 6, FIG. 9 and FIG. 10, the following effects can be obtained by monitoring the spray condition of coating solution of curtain spray coater 602 shown in FIG. 12 at the standby position and by adjusting to the targeted spray condition.

1) There is no need of actual coating for checking, resulting in no waste of substrate, reduced waste of coating solution and lower cost.

2) Even when coating solution is changed to one having different physical properties such as viscosity or surface tension, adjustment of spray condition of coating solution to the set condition (size of droplets, droplet size distribution, droplet density) becomes easier by monitoring, whereby correspondence to the change of coating solution becomes easier resulting in stable coating.

3) By monitoring spray condition during coating, a foreign substance in the spray can be found prior to coating, foreign substance adhesion defect or striation defect caused by adhesion of mingled foreign substances to the conveyance roller can be prevented, whereby the productivity is improved.

The coating solutions described in Tokkai Nos. 2004-906 and No. 2004-122705 is preferable to form a surface layer related to the present invention. The ink absorption layer of the present invention will now be explained. Porosity of the ink absorption layer means that multiple air spaces are formed of holes of a diameter of approximately 5 to 200 nm. The air spaces are preferably connected meaning they are not isolated spaces. In this case, as a definition of air space, for example, measured values obtained by a mercury pressure process can be used. Next, a preferable porous layer will be explained.

A porous layer is mainly formed of a soft agglomeration between hydrophilic binder and inorganic fine particles. Conventionally, various known methods to form air spaces in a film are for example, as follows; a method to form air spaces by coating, a uniform coating solution onto a substrate which includes plural polymers and resulting in phase separation of the polymers during the drying process; a method to form air spaces by coating a coating solution on a substrate including fine solid particles and a hydrophilic or hydrophobic resin, and soaking the inkjet recording paper in water or liquid including appropriate organic solvent after a dying process, and further dissolving the fine solid particles; another method is to form air spaces by coating a coating solution including a compound which generates bubbles when it forms a film and allowing the compound to further generate bubbles during the drying process; a method to form air spaces coating on a substrate coating solution including porous fine solid particles and hydrophilic binder to make air space in or between the porous fine particles; and a method to form air space by coating a coating solution on a substrate including fine solid particles having a volume larger than the hydrophilic binder and/or fine particle oil droplets with a hydrophilic binder. In the present invention, particularly preferable is inclusion of each type of inorganic fine solid particles at an average droplet diameter of less than 100 nm in a porous layer.

As inorganic particles used for the above object, cited can be, for example, white inorganic pigments, such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatom earth, calcium silicate, magnesium silicate, synthetic amorphous silica, colloidal silica, alumina, colloidal alumina, pseudo boehmite, aluminum hydroxide, lithophone, zeolite, and magnesium hydroxide, etc.

The average droplet diameter of inorganic fine particles is acquired by observing with an electron microscope, the particle itself or particles appearing on a cross section or on surface of the porous layer and by measuring 1,000 random particles to obtain a simple average value (number average). The particle diameter of each particle is the diameter of a circle having an area equivalent to the projected area of the particle.

As inorganic fine particles preferably are solid fine particles selected from among silica, alumina and alumina hydrate.

As silica to be used in the present invention, preferable are silica composed by normal wet method, colloidal silica or silica composed by gas phase method. As fine particle silica preferably used in the present invention, colloidal silica or fine particle silica composed by gas phase method is preferable and more preferable are the fine particles of silica composed by gas phase method because of a higher air space ratio. Further, as to alumina or alumina hydrate, either crystalline or non-crystalline is acceptable and particle of any form such as an indeterminate form, a spherical form or a needle form can be used.

The diameter of inorganic particles is preferably less than 100 nm. For example, in the case of the above fine particle silica of the gas phase method, the average droplet diameter (diameter of particles in a dispersed condition prior to coating) of inorganic particle dispersed in a primary particle state is preferably 100 nm or less, more preferably 4 to 50 nm and most preferably 4 to 20 nm.

As the most preferably used silica composed by the gas phase method wherein the average droplet diameter of the primary particle is 4 to 20 nm, for example, Aerosil® of Nippon Aerosil Co. Ltd. is commercially available. This gas phase method fine particle silica can be easily suctioned and dispersed in water, for example, with the jet stream inductor mixer of Mitamura Riken Kougyou Co. Ltd. and is comparatively easily dispersed to the primary particles.

A water-soluble binder can be used for the ink absorption layer in the present invention. As a water-soluble binder which can be used in the present invention, cited, for example, may be polyvinyl alcohol, gelatin, polyethylene oxide, polyvinylpyrrolidone, polyacrylic acid, polyacrylamide, polyuretane, dextran, dextrin, carrageenans (κ, τ, λ, etc.), agar, pullulan, water-soluble polyvinyl butyral, hydroxyethyl cellulose, carboxymethyl cellulose, etc. It is also possible to use combinations of two or more sorts of these water-soluble binders.

The water-soluble binder preferably used in the present invention is polyvinyl alcohol.

In addition to the ordinary polyvinyl alcohol obtained by hydrolyzing polyvinyl acetate, denatured polyvinyl alcohol such as a polyvinyl alcohol which is applied with cation denaturing of the terminal or anion denatured polyvinyl alcohol having an anionic group, is included in the polyvinyl alcohol preferably used in the present invention.

Polyvinyl alcohol of an average degree of polymerization of 1,000 or more which is obtained by hydrolyzing vinyl acetate is preferably used, and the polyvinyl alcohol of an average degree of polymerization of 1,500-5,000 is more preferable. Moreover, polyvinyl alcohol of saponification degree of 70-100% is preferable, and 80-99.5% is more preferable.

Cation denatured polyvinyl alcohol is polyvinyl alcohol which has an amino group of the primary to tertiary class, and quaternary ammonium in the main chain or side chain of the above polyvinyl alcohol, which is described in Tokkaisyou No. 61-10483, for example, and is obtained by saponifying the copolymer of the ethyleny unsaturated monomer which has a cationic group, and vinyl acetate.

As an ethyleny unsaturated monomer which has a cationic group, the following are cited, for example: trimethyl-(2-acrylamide-2,2-dimethyl ethyl) ammonium chloride, trimethyl-(3-acrylamide-3,3-dimethyl propyl) ammonium chloride, N-vinyl imidazole, N-vinyl-2-methylimidazole, N-(3-dimethylaminopropyl) methacrylamide, hydroxylethyl trimethyl ammonium chloride, trimethyl-(2-methacrylamide propyl) ammonium chloride, N-(1,1-dimethyl-3-dimethylaminopropyl) acrylamide.

The ratio of cation denatured group inclusion monomer of cation denatured polyvinyl alcohol is commonly 0.1 to 10 mole percent but is preferably 0.2 to 5 mole percent compared to vinyl acetate.

Cited examples of anion denatured polyvinyl alcohol are polyvinyl alcohol including anionic groups described in Tokkaihei No. 1-206088, copolymers of vinyl alcohol and vinyl compounds including water-soluble groups described in Tokkaisyou Nos. 61-237681 and 63-307979 and denatured polyvinyl alcohol including water-soluble group described in Tokkaihei No. 7-285265.

As nonion denatured polyvinyl alcohol, cited example are polyvinyl alcohol derivative in which a polyethylene oxide group is added to a part of vinyl alcohol described in Tokkaihei No. 7-9758, block copolymer of vinyl compound including a hydrophobic group and vinyl alcohol described in Tokkaihei No. 8-25795. It is also possible to use combinations of two or more sorts of polyvinyl alcohol with different polymerization degrees or denaturation.

In the present invention, it is preferable to use a polyvalent metal compound as a dye bonding agent and within the scope of achievement of the objective effects of the present invention, a cationic polymer can be employed together with these compounds.

The following are cited as examples of a cationic polymer: polyethyleneimine, poly allylamine, polyvinyl amine, a dicyandiamide polyalkylene polyamine condensation product, a polyalkylene polyamine dicyandiamide ammonium salt condensation product, a dicyandiamide formalin condensation product, an epichlorohydrin dialkyl amine addition polymerization object, diallyl dimethyl ammonium chloride polymer, diallyl dimethyl ammonium chloride and SO₂ copolymer, polyvinyl imidazole, vinyl-pyrrolidone vinyl imidazole copolymer, polyvinyl pyridine, poly amidine, chitosan, cationized starch, vinylbenzyl trimethyl ammonium chloride polymer, (2-methacryloyl oxyethyl) trimethyl ammonium chloride polymer and dimethylamino ethyl methacrylate polymer.

Cationic polymers described in Kagaku Kougyou Jihou Heisei 10, August 15 and 25 and high polymer molecule dye binder described in “Koubunnshi Yakuzai Nyumon” marketed by Sanyou Chemical Industries, Ltd. are cited.

The loading amount of inorganic fine particles used for an ink absorption layer greatly depends on the required amount of ink absorption, air space ratio of the porous layer, type of inorganic pigment and the type of water-soluble binder, however it is generally 5 to 30 g and preferably 10 to 25 g per area of 1 m² of recording sheet.

The ratio between inorganic fine particle and water-soluble binder to be used for an ink absorption layer is normally 2:1 to 20:1, and preferably 3:1 to 10:1 as a mass ratio.

Further, cationic water-soluble polymers having quaternary ammonium in the molecule can be included in an ink absorption layer and 0.1 to 10 g of it is normally used per square meter on an inkjet recording sheet, and preferably 0.2 to 5 g.

On a porous layer, it is preferable that the total amount of air space (air space volume) is larger than 20 ml/m² of recording sheet. In the case of air space volume is less than 20 ml/m², when the ink amount is small during printing, ink absorption is good, however when the ink amount is too large, ink cannot be totally absorbed and causes problems such as degrading of image quality and unacceptably slow drying characteristics.

Regarding a porous layer possessing ink retaining capacity, the air space volume compared to the solid volume is called air space ratio. In the present invention, maintaining the air space ratio to be more than 50 percent is preferable because the air space can be effectively formed without unnecessarily thickening the layer.

As other type of a voids type, except for making an ink absorption layer form using inorganic particles, a polyurethane resin emulsion, a water-soluble epoxy compound, and/or acetoacetylized polyvinyl alcohol are used together for coating, and an ink absorption layer is formed employing a coating solution which is made by further using epichlorohydrin polyamide resin with the above materials. As an polyurethane resin emulsion in this case in which the diameter of its particle, featuring a polycarbonate chain, or a polycarbonate chain and a polyester chain is preferably 3.0 micrometers, and it is still more preferable that the polyurethane resin with which polyurethane resin of the polyurethane resin emulsion made the polyol which has polycarbonate polyol, or a polycarbonate polyol and a polyester polyol, and a fatty-series system isocyanate compound react, has a sulfonic acid group in the intramolecular, and further features an epichlorohydrin polyamide resin and a water-soluble epoxy compound and/or acetoacetylized vinyl alcohol. In the ink absorption layer using the above polyurethane resin, a weak aggregation of cations and anions is formed, and in connection with this, voids which exhibit ink solvent absorbing capability are formed, and are presumed to be able to carry out image formation.

In the present invention, using a hardening agent is preferable. The hardening agent can be added at any period of the inkjet recording paper production and can, for example be added in the coating solution for ink absorption layer formation.

In the present invention, a method to provide a hardening agent of water-soluble binder after ink absorption layer formation can be separately employed, preferably however, it is used in conjunction with a method to add the above hardening agent in a coating solution for ink absorption layer formation.

As a hardening agent, which can be used in the present invention, but only if it causes a curing reaction with a water-soluble binder, there are particularly no restriction, but boric acid and its salt are preferable. In addition, other known substances can be used. Generally, the hardening agents which can be used by the present invention are those compounds which have a group which can react with a water-soluble binder, or the compounds which promote the reaction of different groups which a water-soluble binder has. It is suitably selected and used according to the type of water-soluble binder. As an example of the hardening agent, the following are cited: epoxy system hardening agents (diglycidyl ethyl ether, ethylene glycol diglycidyl ether, 1,4-butanediol diglycidyl ether, 1,6-diglycidyl cyclohexane, N,N-diglycidyl-4-glycidyl oxyaniline, sorbitol polyglycidyl ether, glycerol polyglycidyl ether, etc.); aldehyde system hardening agents (formaldehyde, a glyoxal, etc.); activity halogen system hardening agents (2,4-dichloro-4-hydroxy-1,3,5-s-triazine, etc.); activity vinyl system compounds (1,3,5-tris acryloyl-hexahydro-s-triazine, bis vinyl sulfonyl methyl ether, etc.); and aluminium alum.

“Boric acid or its salts” means the oxacid which uses a boron atom as a neutral atom, and its salt, and, concretely, is orthoboric acid, diboric acid, metaboric acid, tetraboric acid, 5-boric acid, and 8-boric acid.

Boric acid which features a boron atom as a hardening agent and its salt can be used as a single water solution or a mixture of plural types. Specifically, preferable one is a mixed water solution of boric acid and borax.

Though a water solution of boric acid and borax can be used only as a comparatively diluted water solution, a rich solution can be created by mixing both solutions, whereby concentrated coating solution becomes possible. There is a definite advantage to be able to relatively freely control pH of the water solution to be added. The total used amount of the above hardening agent is preferably 1 to 600 mg/g of the above water-soluble binder.

Various additives, except those having been mentioned above, can be used for the ink absorption layer and other layers which are provided according to necessity on the recording paper related to the present invention. For example, the following well-known types of additives can also be added: polystyrene, polyacrylic acid, polymethacrylic acid ester, polyacrylamides, polyethylene, polypropylene polyvinylchloride, polyvinylidene chloride, or their copolymers; organic latex particles, such as urea resin or melamine resin; each of anionic, cationic, nonionic, and betaine type surfactants; UV absorbers described in Tokkaisyou Nos. 57-74193, 57-87988, and 62-261476; anti-discoloring agents described in Tokkaisyou Nos. 57-74192, 57-87989, 60-72785 and 61-146591, Tokkaihei Nos. 1-95091 and 3-13376, etc.; optical brightening agent described by Tokkaisyou Nos. 59-42993, 59-52689, 62-280069 and 61-242871, Tokkaihei No. 4-219266, etc.; PH adjusters, such as sulfuric acid, phosphoric acid, citric acid, sodium hydroxide, potassium hydroxide, and potassium carbonate; anti-foaming agents; disinfectants; thickening agents; antistatic additives; and matting powders.

The ink absorption layer can be composed of plural layers, in such case, each layer may either be the same as or different from each other.

A porous layer like the above is preferably employed in an ink jet recording method. The preferable air space volume of the porous layer of the inkjet recording method is 10 to 30 ml/m².

The coated layer on the recording sheet of the present invention can be created by commonly known coating methods, preferably employed examples of which are: a gravure coating method, a roll coating method, a rod-bar coating method, an air knife coating method, a spray coating method, an extrusion coating method, a slide bead coating method, a curtain coating method, a slot nozzle spray coating method or an extrusion coating method using a hopper, as described in U.S. Pat. No. 2,681,294.

Various additives can be used for each layer of the recording sheet related to the present invention.

Various of the following well-known types of additives can also be added: polystyrene, polyacrylic acid, polymethacrylic acid ester, polyacrylamides, polyethylene, polypropylen, polyvinylchloride, polyvinylidene chloride, or these copolymers; organic latex particles, such as a urea resin or melamine resin; each of anionic, cationic, nonionic, and betaine type surfactants; UV absorbers described in Tokkaisyo Nos. 57-74193, 57-87988 and 62-261476; anti-discoloring agent described in Tokkaisyou Nos. 57-74192, 57-87989, 60-72785 and 61-146591, Tokkaihei Nos. 1-95091 and 3-13376, etc.; optical brightening agents described in Tokkaisyou Nos. 59-42993, 59-52689, 62-280069 and 61-242871, and Tokkaihei No. 4-219266, etc.; PH adjusters, such as sulfuric acid, phosphoric acid, citric acid, sodium hydroxide, potassium hydroxide, and potassium carbonate; anti-foaming agents; disinfectants; thickening agents; antistatic additives; and matting powders.

As for the substrate which can be used in the present invention, conventionally known inkjet recording sheets may be appropriately used and can be a water-philic absorbent substrate but a water-phobic absorbent substrate is more preferable. Since more of the water soluble organic solvent in the pigment ink remains on the recording sheet in the case of a water-phobic absorbent substrate and has more effective action on fine organic particle solvents or the like than in the case of a water-philic absorbent substrate. It is therefore assumed that the desired effects of the present invention can be more markedly exhibited. Specifically, use of “a substrate which does not absorb water-soluble organic solvent in ink” is preferable, however it is assumed that a non-water absorbent substrate can exhibit markedly desirable effects of the present invention.

As a water absorbent substrate which can be used in the present invention, for example, ordinary paper, cloth, sheets or plates including wood, are cited, of which paper is the most preferable due to its excellent water absorption and low cost. As a paper substrate, chemical pulp, such as LBKP and NBKP; mechanical pulp such as GP, CGP, RMP, TMP, CTMP, CMP, PGW; and substrates including wood pulp of waste paper as the main material such as DIP are usable. According to necessity, various types of fibrous substance such as synthetic pulp, synthetic fiber, and inorganic fibers can be appropriately employed as a substrate material.

In the above paper substrate, various types of known additive such as sizing agents, pigments, paper strengthening additives, bonding agents, fluorescent brightening agents, wet strength agents and cationic agents can be added.

Paper substrates can be produced by mixing of the above fibrous substance such as wood pulp and various types of additive and manufactured with various kinds of paper machines such as a fourdrinier paper machine, a cylinder paper machine and a twin wire paper machine. According to necessity, via a paper making step or via a paper machine, a size pressing process with starch and polyvinyl alcohol, various coating processes or a calendaring process can be applied to the paper.

A transparent substrate or an opaque substrate are, cited as water-phobic absorbent substrate which is preferably used by the present invention. As a transparent substrate, materials formed as films, such as polyester system resin, diacetate system resin, triacetate system resin, acrylic system resin, polycarbonate system resin, polyvinylchloride system resin, polyimide system resin, cellophane, and celluloid, are cited, as examples. A transparent substrate with the property to resist radiated heat, as when used as a substrate for overhead projectors (OHP) is preferable, and of which particularly preferable is a polyethylene terephthalate. As for the thickness of such colorless substrate, 50-200 micrometers is preferable.

Preferable examples of an opaque substrate are resin coated paper (so-called RC paper) having polyethylene terephthalate resin coated layer added with a white pigment or the like on at least one side of the base paper, and so-called white PET in which white pigment such as barium sulfate or the like is added to polyethylene terephthalate.

To increase adhesive strength between the various types of substrates and ink absorption layers above, applying a corona discharge treatment or a sub-coating on the substrate is preferable prior to coating of the ink absorption layer. The recording sheet related to the present invention is not necessarily colorless and can be a colored recording sheet.

As a recording sheet related to the present invention, a base paper substrate both surfaces of which are laminated with polyethylene described in Tokkai No. 2004-122705 is usable. It is preferable because the quality of recorded images is close to that of photography and high quality images can be obtained at low cost.

Preferably employed coating methods are: a roll coating method, a rod-bar coating method, an air knife coating method, a spray coating method, a curtain coating method or an extrusion coating method using a hopper described in U.S. Pat. No. 2,681,294. As the ink absorption layer, it is preferably composed of porous layers described in Tokkai No. 2004-122705.

### EXAMPLES

The present invention will now be described with specific reference to examples. However, the embodiments of the present invention are not to be construed as being limited to these examples. Incidentally, “%” in the examples represents percent by mass unless specially stated otherwise.

### Example 1

Recording paper was produced employing a coating production line shown in FIG. 1.

<Production of a Belt-Shaped Substrate Coated with a Porous Ink Absorption Layer>

(Preparation of Dispersion)

100 g of 15% water solution of cationic polymer (P1) was added with 500 g of 25% water dispersion of fine particle silica (QS-20, manufactured by Tokuyama Corp) having an average primary particle diameter of 12 μm, followed by 3.0 g of boric acid and 0.7 g of pyroborate, and then the resulting mixture was dispersed employing a high-speed homogenizer, thereby a blue-white colored and clear dispersion was obtained.

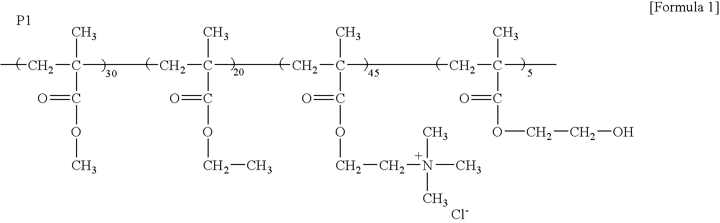

(Preparation of a Coating Solution)

The temperature of dispersion prepared as described above was raised to 45° C., and added with 10% water solution of polyvinyl alcohol (PVA203, manufactured by Kuraray Co., Ltd.) and 6% water solution of polyvinyl alcohol (PVA245, manufactured by Kuraray Co., Ltd.) after the temperature of the respective water solution has been raised to 45° C. Then, the liquid volume was adjusted by adding pure water at 45° C. to obtain a translucent coating solution.

(Coating)

On a paper substrate (1500 mm width, 230 μm thick) having the both surfaces coated with polyethylene, employing a slide-bead coating machine, the coating solution prepared as described above was applied and then dried to produce a 15,000 m of belt-shaped substrate coated with the porous ink absorption layer. The coating speed was 200 m/min. The quantities to be added of each of the components in the lower layer of the belt-shaped substrate coated with the porous ink absorption layer are as follows. The dried layer is 35 μm thick.

| | |
|---|---|
| Fine Particle Silica: | 15 g/m² |
| Cationic Polymer (P1): | 2.2 g/m² |
| Polyvinyl Alcohol: | 2.3 g/m² |

After having been coated with the coating solution for ink absorption layer, the temperature of the coated surface was lowered to 10° C. or below by causing it to pass through a cooling zone constantly maintained at 10° C. for 15 seconds, and subsequently dried by causing it to pass through each of the zones of the drying process with blowing air at lower temperature successively onto the ink absorption layer surface.

The entire drying process in the first drying part was set to 360 seconds, and for the first 270 seconds, an average relative humidity of the blowing air was set to 30% or below. After the 270 seconds, the drying process was set to a humidity control zone with a relative humidity of 40 through 60%.

<Preparation of a Spray Coating Device>

There were prepared a spay coater, coating solution scatter prevention means, and monitoring means comprising a spray coating device described hereinafter.

(Preparation of a Spray Coater)

A spay coater shown in FIGS. 6 to 8 was prepared. The spay coater prepared herein was set to a coating width of 1470 mm, a gap width of a nozzle for coating solution of 60 μm, and a gap width of a nozzle for air of 200 μm. The angle of the nozzle for air relative to the nozzle for coating solution was set to 40 deg. Provided and inserted into the gap of the nozzle for coating solution was a comb-shaped member shown in FIG. 8, and the pitch of the comb-teeth was set to 500 μm. The angle made by the spray coater and the substrate crossing each other was set to 90°.

(Preparation of Coating Solution Scatter Prevention Means)

Coating solution scatter prevention means were prepared as shown in FIGS. 4 and 5 with the opening area varied as shown in Table 1, represented by 1-a through 1-f. The length of the current plate (the ratio relative to the height of the opening (%)) was set to 80%, the mounting position of the current plate (the distance from the upper end of the main body of the coating solution scatter prevention means to the mounting position of the current plate) was set to 10 mm, and the thickness of the current plate was set to 5 mm. Acrylic resin was used for the main body of the coating solution scatter prevention means as well as for the current plate. The upper side of the main body of the coating solution scatter prevention means was applied with polyacrylamide-based absorption member. The area of the opening indicates the ratio relative to the area of the spaying (%).

TABLE 1

| Coating solution | Opening | Current plate | Current plate | Current plate | |
|---|---|---|---|---|---|
| scatter prevention | area | length | mounting position | thickness | |
| means No. | (%) | (%) | (mm) | (mm) | Remarks |
| 1-a | 90 | 80 | 10 | 5 | Comparison |
| 1-b | 100 | 80 | 10 | 5 | Present |
| | | | | | invention |
| 1-c | 300 | 80 | 10 | 5 | Present |
| | | | | | invention |
| 1-d | 500 | 80 | 10 | 5 | Present |
| | | | | | invention |
| 1-e | 700 | 80 | 10 | 5 | Present |
| | | | | | invention |
| 1-f | 710 | 80 | 10 | 5 | Comparison |

(Preparation of a Monitoring Means)

A high-speed-video camera (manufactured by Photron Limited) was used as a monitoring means.

[Coating of a Surface Layer]

Upon completion of the falling rate drying of the dry ink absorption layer in the drying part shown in FIG. 1, employing a spray coating device shown in FIGS. 3 through 7, a line forming a spray opening of the spray coater was provided, as shown in FIG. 3, parallel to the substrate and crossing the traveling direction of the substrate at a 90° angle. The gas suction quantity via the gas suction means of the prepared coating solution scatter prevention means No. 1-a through 1-f was varied as shown in Table 2, for each of which the coating solution for surface layer was spray-coated for 100 m to make a wet film of 15 μm thick, employing a belt-shaped substrate coated with the porous ink absorption layer, and then dried to produce recording materials having surface layers, which were represented by the samples Nos. 101 through 130. The entire drying process after the spray coating was set to 100 sec., while blowing air with a relative humidity ranging from 40 to 60%. The coating solution used herein was filtered with a filter having a bore of one twentieth relative to a 60 μm gap width of the nozzle for coating solution. The air used herein were filtered with a filter having a bore of one fiftieth relative to a 200 μm gap width of the nozzle for air.

The gas supply quantity ejected from the nozzle for air was set to 18 CMM/m (the current quantity per coating width), whereat the inner pressure in the nozzle for air was set to 10 kPa. The air linear velocity v was set to 150 m/s. The gap between the spray opening of the spray coater and the ink absorption layer was set to 20 mm, and the coating speed was set to 200 m/sec. The gas suction quantity indicates the ratio relative to the gas supply quantity of the spray coater (%).

<Preparation of a Coating Solution for Surface Layer>

A coating solution composed of the following components was prepared.

Polychlorinated Aluminum: 160 ml (PAC250A, solid content 23.5%, manufactured by Taki Chemical Co. Ltd.)

Water: 840 ml

The degree of viscosity was 0.9 mPa at 25° C. by the result of the measurement carried out with a B-type viscometer. Incidentally, the surface tension was adjusted to be 40 mN/m by a surface active agent.

(Evaluation)

For each of the samples Nos. 101 through 130 produced as described above, visual judgment was made in relation to the coating yield and coating irregularities from the start to the end of the coating, and then evaluation was made according to the following evaluation ranks. The results are shown in Table 2. The coating yield was calculated by the measured concentration/theoretical concentration×100, and was evaluated according to the following evaluation ranks. The measured concentration was that for each of the samples, measurements were carried out from the start to the end of the coating at 10 locations with intervals of 10 m in the width direction, and the average value was calculated from all of the measurements. The theoretical concentration was obtained by previously making analytical curves showing the relation between the coated film thickness and the concentration.

Evaluation Rank of the Coating Yield

A: Coating yield ranging from 0.98 through 100%

B: Coating yield 95 or more and less than 98%

C: Coating yield less than 95%

Evaluation Rank of Coating Irregularities

A: No coating irregularities observed on the coating surface

B: Coating irregularities observed within the acceptable range for the application on the coating surface

C: Impossible commercialization due to strong coating irregularities

TABLE 2

| | Coating | Gas | | | |
|---|---|---|---|---|---|
| | solution scatter | suction | | | |
| Sample | prevention | quantity | Coating | Coating | |
| No. | means No. | (%) | yield | irregularities | Remarks |
| 101 | 1-a | 90 | C | B | Comparison |
| 102 | 1-a | 100 | C | C | Comparison |
| 103 | 1-a | 200 | C | C | Comparison |
| 104 | 1-a | 300 | C | C | Comparison |
| 105 | 1-a | 310 | C | C | Comparison |
| 106 | 1-b | 90 | C | B | Comparison |
| 107 | 1-b | 100 | A | B | P.I. |
| 108 | 1-b | 200 | A | A | P.I. |
| 109 | 1-b | 300 | B | A | P.I. |
| 110 | 1-b | 310 | C | C | Comparison |
| 111 | 1-c | 90 | C | B | Comparison |
| 112 | 1-c | 100 | A | A | P.I. |
| 113 | 1-c | 200 | A | A | P.I. |
| 114 | 1-c | 300 | A | A | P.I. |
| 115 | 1-c | 310 | C | C | Comparison |
| 116 | 1-d | 90 | C | B | Comparison |
| 117 | 1-d | 100 | A | A | P.I. |
| 118 | 1-d | 200 | A | A | P.I. |
| 119 | 1-d | 300 | A | A | P.I. |
| 120 | 1-d | 310 | C | C | Comparison |
| 121 | 1-e | 90 | C | C | Comparison |
| 122 | 1-e | 100 | A | A | P.I. |
| 123 | 1-e | 200 | A | A | P.I. |
| 124 | 1-e | 300 | A | A | P.I. |
| 125 | 1-e | 310 | C | B | Comparison |
| 126 | 1-f | 90 | C | B | Comparison |
| 127 | 1-f | 100 | C | C | Comparison |
| 128 | 1-f | 200 | C | C | Comparison |
| 129 | 1-f | 300 | C | C | Comparison |
| 130 | 1-f | 310 | C | C | Comparison |

P.I.: Present Invention

In the case of the samples Nos. 101 through 105 which were produced employing a spray coating device having an opening area of less than 100%, the air flow between the spray coater and the substrate became turbulent due to the flow rate during the gas suction being much faster than required, so that the spaying was not carried out uniformly, thereby the decrease of the coating yield and the occurrence of the coating irregularities were confirmed.

In the case of the samples Nos. 126 through 130 which were produced employing a spray coating device having an opening area of more than 700%, as the gas suction pressure for preventing the coating solution scatter had to suck with a pressure greater than the tension of the substrate acting on a backup roll, the fluttering of the substrate occurred, so that a uniform spry-coating could not be carried out, thereby the coating irregularities were confirmed. Also, a portion of the droplets of the sprayed coating solution was sucked before reaching the substrate, so that the coating quantity toward the substrate decreased, thereby the decrease of the coating yield was confirmed.

In the case of the samples Nos. 101, 106, 111, 116, 121 and 126 which were produced by setting the gas suction quantity of the suction means to 90% relative to the gas supply quantity of the spray coater, the misty coating solution without being used for the coating adhered to the inside of the coating solution scatter prevention means, and became liquid drops and fell down, resulting in the occurrence of the coating irregularities. In addition, as a portion of the droplets of the sprayed coating solution scattered before reaching the substrate, the uniform spraying could not be carried out and the coating irregularities occurred, and further the coating quantity toward the substrate decreased, thereby the decrease of the coating yield was confirmed. In the case of the samples Nos. 105, 110, 115, 120, 125 and 130 which were produced by setting the gas suction quantity of the suction means to 310% relative to the gas supply quantity of the spray coater, the misty coating solution was turbulent due to the gas flow inside the coating solution scatter prevention means, so that the constant coating on the substrate could not be carried out, resulting in the occurrence of the coating irregularities. Further, a portion of the droplets of the sprayed coating solution was sucked before reaching the substrate, so that the coating quantity toward the substrate decreased, thereby the decrease of the coating yield was confirmed.

In the visual observation of the samples, failure locations were previously read out based on the information from the monitoring means and then observed, and as a result, it was confirmed that the information from the monitoring means and the failure locations visually observed were identified. When the opening area of the coating solution scatter prevention means was set to 100 through 700% relative to the spraying area and the gas suction quantity of the suction means was set to 100 through 300% relative to the gas supply quantity of the spay coater, the possible constant coating without any coating yield decrease nor observed coating irregularities was confirmed so that the reliability of the monitoring means, as well as the effectiveness of the present invention was confirmed.

### Example 2

<Production of a Belt-Shaped Substrate Coated with a Porous Ink Absorption Layer>

It was produced by the same method as in Example 1.

<Preparation of a Spay Coating Device>

There were prepared a spray coater, coating solution scatter prevention means, and monitoring means comprising the spray coating device described hereinafter.

(Preparation of a Spay Coater)

The same spay coater as in Example 1 was prepared.

(Preparation of Coating Solution Scatter Prevention Means)

Coating solution scatter prevention means shown in FIGS. 4 and 5 were prepared with the length of the current plate varied as shown in Table 3, which were represented by Nos. 2-a through 2-e. The opening area (the ratio relative to the spaying area (%)) was set to 300%, the mounting position of the current plate (the distance from the upper end of the main body of the coating solution scatter prevention means to the mounting position of the current plate) was set to 10 mm, and the current plate thickness was set to 5 mm. Acrylic resin was used for the main body of the coating solution scatter prevention means as well as for the current plate. The upper side of the main body of the coating solution scatter prevention means was applied with a polyacrylamide based absorbing member.

TABLE 3

| Coating | | | Current | |
|---|---|---|---|---|
| solution | | Current | plate | Current |
| scatter | Opening | plate | mounting | plate |
| prevention | area. | length | position | thickness |
| means No. | (%) | (%) | (mm) | (mm) |
| 2-a | 300 | 45 | 10 | 5 |
| 2-b | 300 | 50 | 10 | 5 |
| 2-c | 300 | 60 | 10 | 5 |
| 2-d | 300 | 70 | 10 | 5 |
| 2-e | 300 | 80 | 10 | 5 |
| 2-f | 300 | 85 | 10 | 5 |

(Preparation of a Monitoring Means)

The same as in Example 1 was prepared.

[Coating of a Surface Layer]

Upon completion of the falling rate drying of the dry ink absorption layer in the drying part shown in FIG. 1, employing a spray coating device shown in FIGS. 2 through 7, a line forming a spray opening of the spray coater was provided, as shown in FIG. 3, parallel to the substrate and crossing the traveling direction of the substrate at a 90° angle. The coating solution for surface layer was coated in the same conditions as those in Example 1, except that the gas suction quantity via the suction means of the prepared coating solution scatter prevention means No. 2-a through 2-f was varied as shown in Table 4, and then dried to produce recording materials having surface layers, which were represented by the samples Nos. 201 through 225. The gas suction quantity indicates the ratio (%) relative to the air supply quantity of the spay coater. The gas supply quantity from the gas supply means of the coating solution scatter prevention means was set to 3.5 m³/min. The coating solution for surface layer used herein was colored by adding a dye into the same liquid as in Example 1.

(Evaluation)

For each of the samples Nos. 201 through 230 produced as described above, judgement and evaluation were made in relation to the coating irregularities and the coating yield. The results of the evaluation are shown in Table 4. The coating yield and coating irregularities from the start to the end of the coating were visually judged and evaluated according to the same evaluation ranks as those in Example 1.

TABLE 4

| | Coating | Gas | | | |
|---|---|---|---|---|---|
| | solution scatter | suction | | | |
| Sample | prevention | quantity | Coating | Coating | |
| No. | means No. | (%) | yield | irregularities | Remarks |
| 201 | 2-a | 90 | C | C | Comparison |
| 202 | 2-a | 100 | B | B | P.I. |
| 203 | 2-a | 200 | A | B | P.I. |
| 204 | 2-a | 300 | A | A | P.I. |
| 205 | 2-a | 310 | C | C | Comparison |
| 206 | 2-b | 90 | C | C | Comparison |
| 207 | 2-b | 100 | A | B | P.I. |
| 208 | 2-b | 200 | A | A | P.I. |
| 209 | 2-b | 300 | A | A | P.I. |
| 210 | 2-b | 310 | C | C | Comparison |
| 211 | 2-c | 90 | C | C | Comparison |
| 212 | 2-c | 100 | A | A | P.I. |
| 213 | 2-c | 200 | A | A | P.I. |
| 214 | 2-c | 300 | A | A | P.I. |
| 215 | 2-c | 310 | C | C | Comparison |
| 216 | 2-d | 90 | B | C | Comparison |
| 217 | 2-d | 100 | A | A | P.I. |
| 218 | 2-d | 200 | A | A | P.I. |
| 219 | 2-d | 300 | A | A | P.I. |
| 220 | 2-d | 310 | B | C | Comparison |
| 221 | 2-e | 90 | B | C | Comparison |
| 222 | 2-e | 100 | A | A | P.I. |
| 223 | 2-e | 200 | A | A | P.I. |
| 224 | 2-e | 300 | A | A | P.I. |
| 225 | 2-e | 310 | B | C | Comparison |
| 226 | 2-f | 90 | B | C | Comparison |
| 227 | 2-f | 100 | B | B | P.I. |
| 228 | 2-f | 200 | A | B | P.I. |
| 229 | 2-f | 300 | A | A | P.I. |
| 230 | 2-f | 310 | B | C | Comparison |

P.I.: Present invention

In the case of the samples Nos. 201, 206, 211, 216, 221 and 206 which were produced by setting the opening area to 300% relative to the spraying area and the gas suction quantity of the suction means to 90% relative to the gas supply quantity of the spray coater, the misty coating solution without being used for the coating adhered to the inside of the coating solution scatter prevention means, and formed liquid drops and fell down, resulting in the occurrence of the coating irregularities.

In the case of the samples Nos. 205, 210, 215, 220, 225 and 230 which were produced by setting the opening area to 300% relative to the spraying area and the gas suction quantity of the suction means to 310% relative to the gas supply quantity of the spray coater, the misty coating solution was turbulent due to the gas flow inside the coating solution scatter prevention means, so that the constant coating on the substrate could not be carried out, resulting in the occurrence of the coating irregularities. In addition, a portion of the droplets of the misty coating solution was sucked more than required into the coating solution scatter prevention means, so that the coating rate toward the substrate lowered, thereby the coating yield deceased. When the length of the current plate within the coating solution scatter prevention means became shorter, the suction speed of the misty coating solution became faster, so that it was seen that the coating rate was apt to lower. When the length of the current plate within the coating solution scatter prevention means became longer, the gas flow at the end portion of the current plate became faster, so that the misty coating solution was apt to be turbulent, thereby it was confirmed that the coating irregularities more likely occurred. In the visual observation of the samples, failure locations were previously read out based on the information from the monitoring means and then observed, and as a result, it was confirmed that the information from the monitoring means and the failure locations visually observed were identified.

When the opening area of the coating solution scatter prevention means was set to within the range of the present invention, the gas suction quantity of the suction means was set to 100 through 300% relative to the gas supply quantity of the spay coater, the length and mounting position and thickness of the current plate were respectively set to within the preferred ranges of the present invention, and also by employing the monitoring means, the possible constant coating without any coating yield decrease nor observed coating irregularities and the reliability of the monitoring means, as well as the effectiveness of the present invention were confirmed.

### Example 3

<Production of a Belt-Shaped Substrate Coated with a Porous Ink Absorption Layer>

It was produced in the same method as in Example 1.

<Preparation of a Spray Coating Device>

There were prepared a spray coater, coating solution scatter prevention means, and monitoring means comprising the spray coating device described hereinafter.

<Preparation of a Spray Coater>

The same spray coater as in Example 1 was prepared.

(Preparation of Coating Solution Scatter Prevention Means)

Coating solution scatter prevention means shown in FIGS. 4 and 5 were prepared with the mounting position of the current plate (the distance from the upper end of the main body of the coating solution scatter prevention means to the mounting position of the current plate) varied as shown in Table 5, which were represented by Nos. 3-a through 3-e. The opening area (the ratio relative to the spraying area (%)) was set to 300%, the length of the current plate (the ratio relative to the height of the opening (%)) was set to 60%, and the thickness of the current plate was set to 5 mm. Acrylic resin was used for the main body of the coating solution scatter prevention means as well as for the current plate. The upper side of the main body of the coating solution scatter prevention means was applied with a polyacrylamide based absorbing member.

TABLE 5

| Coating | | | Current | |
|---|---|---|---|---|
| solution | | Current | plate | Current |
| scatter | Opening | plate | mounting | plate |
| prevention | area. | length | position | thickness |
| means No. | (%) | (%) | (mm) | (mm) |
| 3-a | 300 | 80 | 3 | 5 |
| 3-b | 300 | 80 | 5 | 5 |
| 3-c | 300 | 80 | 10 | 5 |
| 3-d | 300 | 80 | 20 | 5 |
| 3-e | 300 | 80 | 30 | 5 |
| 3-f | 300 | 80 | 32 | 5 |

(Preparation of a Monitoring Means)

The same as in Example 1 was prepared.

[Coating of a Surface Layer]

Upon completion of the falling rate drying of the dry ink absorption layer in the drying part shown in FIG. 1, employing a spray coating device shown in FIGS. 3 through 7, a line forming a spray opening of the spray coater was provided, as shown in FIG. 3, parallel to the substrate and crossing the traveling direction of the substrate at a 90° angle. The coating solution for surface layer was coated in the same conditions as those in Example 1, except that the gas suction quantity via the gas suction means of the prepared coating solution scatter prevention means No. 3-a through 3-f was varied as shown in Table 6, and then dried to produce recording materials having surface layers, which were represented by the samples Nos. 301 through 330. The gas suction quantity indicates the ratio relative to the air supply quantity of the spray coater (%).

(Evaluation)

For each of the samples Nos. 301 to 330 prepared as described above, visual judgment was made in relation to the coating yield, the coating irregularities associated with the liquid drops falling, and then evaluation was made according to the same evaluation ranks as those in Example 1. The results are shown in Table 6.

TABLE 6

| | Coating | Gas | | | |
|---|---|---|---|---|---|
| | solution scatter | suction | | | |
| Sample | prevention | quantity | Coating | Coating | |
| No. | means No. | (%) | yield | irregularities | Remarks |
| 301 | 3-a | 90 | C | C | Comparison |
| 302 | 3-a | 100 | B | B | P.I. |
| 303 | 3-a | 200 | A | A | P.I. |
| 304 | 3-a | 300 | A | A | P.I. |
| 305 | 3-a | 310 | C | C | Comparison |
| 306 | 3-b | 90 | C | C | Comparison |
| 307 | 3-b | 100 | B | B | P.I. |
| 308 | 3-b | 200 | A | A | P.I. |
| 309 | 3-b | 300 | A | A | P.I. |
| 310 | 3-b | 310 | C | C | Comparison |
| 311 | 3-c | 90 | B | C | Comparison |
| 312 | 3-c | 100 | A | A | P.I. |
| 313 | 3-c | 200 | A | A | P.I. |
| 314 | 3-c | 300 | A | A | P.I. |
| 315 | 3-c | 310 | B | C | Comparison |
| 316 | 3-d | 90 | B | C | Comparison |
| 317 | 3-d | 100 | A | A | P.I. |
| 318 | 3-d | 200 | A | A | P.I. |
| 319 | 3-d | 300 | A | A | P.I. |
| 320 | 3-d | 310 | B | C | Comparison |
| 321 | 3-e | 90 | C | C | Comparison |
| 322 | 3-e | 100 | A | A | P.I. |
| 323 | 3-e | 200 | A | A | P.I. |
| 324 | 3-e | 300 | A | A | P.I. |
| 325 | 3-e | 310 | C | C | Comparison |
| 326 | 3-f | 90 | C | C | Comparison |
| 327 | 3-f | 100 | B | B | P.I. |
| 328 | 3-f | 200 | A | A | P.I. |
| 329 | 3-f | 300 | A | A | P.I. |
| 330 | 3-f | 310 | C | C | Comparison |

P.I.: Present invention

In the case of the samples Nos. 301, 306, 311, 316, 321 and 326 which were produced by setting the opening area to 300% relative to the spraying area, the gas suction quantity of the suction means to 90% relative to the gas supply quantity of the spray coater, the misty coating solution without being used for the coating adhered to the inside of the coating solution scatter prevention means, and formed liquid drops and fell down, resulting in the occurrence of the coating irregularities.

In the case of the samples Nos. 305, 310, 315, 320, 325 and 330 which were produced by setting the opening area to 300% relative to the spraying area and the gas suction quantity of the suction means to 310% relative to the gas supply quantity of the spray coater, the misty coating solution was turbulent due to the gas flow inside the coating solution scatter prevention means, so that the constant coating on the substrate could not be carried out, thereby the coating irregularities occurred. In addition, the droplets of the misty coating solution were sucked more than required into the coating solution scatter prevention means, so that the coating rate toward the substrate lowered, thereby the decrease of the coating yield was confirmed. Further, in the visual observation of the samples, failure locations were previously read out based on the information from the monitoring means and then observed, and as a result, it was confirmed that the information from the monitoring means and the failure locations visually observed were identified.

When the opening area of the coating solution scatter prevention means was set to within the range of the present invention, the gas suction quantity of the suction means was set to 100 through 300% relative to the gas supply quantity of the spay coater, the length and mounting position and thickness of the current plate were respectively set to within the preferred ranges of the present invention, and also by employing the monitoring means, the possible constant coating without any coating yield decrease nor observed coating irregularities and the reliability of the monitoring means, as well as the effectiveness of the present invention were confirmed.

### Example 4

<Production of a Belt-Shaped Substrate Coated with a Porous Ink Absorption Layer>

It was produced with the same method as in Example 1.

<Preparation of a Spray Coating Device>

There were prepared a spray coater, coating solution scatter prevention means, monitoring means comprising the spray coating device described hereinafter.

(Preparation of a Spray Coater)

The same spray coater as in Example 1 was prepared.

(Preparation of Coating Solution Scatter Prevention Means)

Coating solution scatter prevention means shown in FIGS. 4 and 5 were prepared with the thickness of the current plate varied as shown in Table 7, which were represented by No. 4-a through 4-e. The opening area (the ratio relative to the spraying area (%)) was set to 300%, the length of the current plate (the ratio relative to the height of the opening (%)) was set to 80%, and the mounting position of the current plate (the distance from the upper end of the main body of the coating solution scatter prevention means to the mounting position of the current plate) was set to 10 mm. Acrylic resin was used for the main body of the coating solution scatter prevention means as well as for the current plate. The upper side of the main body of the coating solution scatter prevention means was applied with a polyacrylamide based absorbing member.

TABLE 7

| Coating | | | Current | |
|---|---|---|---|---|
| solution | | Current | plate | Current |
| scatter | Opening | plate | mounting | plate |
| prevention | area. | length | position | thickness |
| means No. | (%) | (%) | (mm) | (mm) |
| 4-a | 300 | 80 | 10 | 2 |
| 4-b | 300 | 80 | 10 | 3 |
| 4-c | 300 | 80 | 10 | 5 |
| 4-d | 300 | 80 | 10 | 10 |
| 4-e | 300 | 80 | 10 | 20 |
| 4-f | 300 | 80 | 10 | 21 |

(Preparation of a Monitoring Means)

The same as in Example 1 was prepared.

[Coating of a Surface Layer]

Upon completion of the falling rate drying of the dry ink absorption layer in the drying part shown in FIG. 1, employing a spray coating device shown in FIGS. 3 through 7, a line forming a spray opening of the spray coater was provided, as shown in FIG. 3, parallel to the substrate and crossing the traveling direction of the substrate at a 90° angle. The coating solution for surface layer was coated in the same conditions as those in Example 1, except that the gas suction quantity via the suction means of the prepared coating solution scatter prevention means Nos. 4-a through 4-f was varied as shown in Table 8, and then dried to produce recording materials having surface layers, which were represented by the samples Nos. 401 through 430. The gas suction quantity indicates the ratio relative to the air supply quantity of the spay coater (%).

(Evaluation)

For each of the samples Nos. 401 through 430 prepared as described above, visual judgement was made in relation to the coating yield, the coating irregularities associated with the liquid drops falling, and then evaluation was made according to the same evaluation ranks as those in Example 1. The results are shown in Table 8.

TABLE 8

| | Coating | Gas | | | |
|---|---|---|---|---|---|
| | solution scatter | suction | | | |
| Sample | prevention | quantity | Coating | Coating | |
| No. | means No. | (%) | yield | irregularities | Remarks |
| 401 | 4-a | 90 | C | C | Comparison |
| 402 | 4-a | 100 | B | B | P.I. |
| 403 | 4-a | 200 | A | A | P.I. |
| 404 | 4-a | 300 | A | A | P.I. |
| 405 | 4-a | 310 | C | C | Comparison |
| 406 | 4-b | 90 | C | C | Comparison |
| 407 | 4-b | 100 | B | B | P.I. |
| 408 | 4-b | 200 | A | A | P.I. |
| 409 | 4-b | 300 | A | A | P.I. |
| 410 | 4-b | 310 | C | C | Comparison |
| 411 | 4-c | 90 | C | C | Comparison |
| 412 | 4-c | 100 | A | A | P.I. |
| 413 | 4-c | 200 | A | A | P.I. |
| 414 | 4-c | 300 | A | A | P.I. |
| 415 | 4-c | 310 | C | C | Comparison |
| 416 | 4-d | 90 | C | C | Comparison |
| 417 | 4-d | 100 | A | A | P.I. |
| 418 | 4-d | 200 | A | A | P.I. |
| 419 | 4-d | 300 | A | A | P.I. |
| 420 | 4-d | 310 | C | B | Comparison |
| 421 | 4-e | 90 | C | B | Comparison |
| 422 | 4-e | 100 | A | A | P.I. |
| 423 | 4-e | 200 | A | A | P.I. |
| 424 | 4-e | 300 | A | A | P.I. |
| 425 | 4-e | 310 | C | B | Comparison |
| 426 | 4-f | 90 | C | C | Comparison |
| 427 | 4-f | 100 | B | B | P.I. |
| 428 | 4-f | 200 | A | A | P.I. |
| 429 | 4-f | 300 | A | A | P.I. |
| 430 | 4-f | 310 | C | C | Comparison |

P.I.: Present invention

In the case of the samples Nos. 401, 406, 411, 416, 421 and 426 which were produced by setting the opening area to 300% relative to the spraying area and the gas suction quantity of the suction means to 90% relative to the gas supply quantity of the spray coater, the misty coating solution without being used for the coating adhered to the inside of the coating solution scatter prevention means, and formed liquid drops and fell down, thereby the coating irregularities occurred.

In the case of the samples Nos. 405, 410, 415, 420, 425 and 430 which were produced by setting the opening area to 300% relative to the spraying area and the gas suction quantity of the suction means to 310% relative to the gas supply quantity of the spray coater, the misty coating solution was turbulent due to the gas flow inside the coating solution scatter prevention means, so that the constant coating on the substrate could not be carried out, thereby the coating irregularities occurred. In addition, the drops of the misty coating solution were sucked more than required into the coating solution scatter prevention means, so that the coating rate toward the substrate lowered, thereby the decrease of the coating yield was confirmed. In the visual observation of the samples, failure locations were previously read out based on the information from the monitoring means and then observed, and as a result, it was confirmed that the information from the monitoring means and the failure locations visually observed were identified.

When the opening area of the coating solution scatter prevention means was set to within the range of the present invention, the gas suction quantity of the suction means was set to 100 through 300% relative to the gas supply quantity of the spay coater, the length and mounting position and thickness of the current plate were respectively set to within the preferred ranges of the present invention, and also by employing the monitoring means, the possible constant coating without any coating yield decrease nor observed coating irregularities and the reliability of the monitoring means, as well as the effectiveness of the present invention were confirmed.

What is claimed is:

1. A spray coating device for coating of a surface layer of an inkjet recording sheet, to form a surface layer by spraying coating solution onto at least one layer of ink absorption layer formed on a substrate, comprising:
a backup roller to support a substrate and to carry out a continuous conveyance of the substrate;
a spray coater placed near a substrate to carry out spray coating of coating solution onto the substrate; and
a coating solution scatter prevention means to prevent sprayed coating solution from scattering;
wherein the coating solution scatter prevention means comprises:
a body having a box-shaped structure with an opening on a side of the spray coater;
a suction device connected to the body to reduce pressure in the body;
wherein the coating solution scatter prevention means is positioned in contact with a wall of the spray coater extending in a longitudinal direction of the spray coater and close to an circumferential surface of the backup roller so that a part of the opening is ensured between the spray coater and a substrate.

2. The spray coating device of claim 1, further comprising:
a monitoring device to monitor a spray condition of coating solution sprayed from the spray coater.

3. The spray coating device of claim 2, comprising:
a transfer device to transfer the spray coater; and
a monitoring mechanism to transfer the monitoring device;
wherein by the transfer device, the spray coater is transferred from a standby position to a coating position when coating starts and is transferred from the coating position to the standby position after coating finishes and
wherein the monitoring mechanism is positioned in the standby position.

4. The spray coating device of claim 1,
wherein an area of the opening is 100 to 700 percent relative to a spray area and a gas suction quantity of the suction device is 100 to 300 percent relative to an air supply quantity of the spray coater.

5. The spray coating device of claim 3, further comprising:
a shutter which opens and closes between the standby position and the coating position, synchronizing with a transfer of the spray coater.

6. The spray coating device of claim 3,
wherein an upper plate of the body of the coating solution scatter prevention means placed on a transfer side of the spray coater to the standby position is transferred linked with the spray coater.

7. The spray coating device of claim 1,
wherein the spray coater is a curtain spray coater.

8. The spray coating device of claim 1,
wherein the ink absorption layer comprises at least one layer of inorganic fine particles and a porous layer including a binder.

9. The spray coating device of claim 1,
wherein a current regulating device is installed inside the body.

10. The spray coating device of claim 2,
wherein the monitoring device is positioned opposite the coating solution scatter prevention means and always monitors a spray condition of coating solution sprayed from the spray coater and then feeds back information of a location of abnormal coating to a coating record.

11. The spray coating device of claim 1,
wherein the coating solution scatter prevention means is transferred from a standby position to a set position linked with a transfer of the spray coater from a standby position to a coating position.

12. The spray coating device of claim 1,
wherein the coating solution scatter prevention means includes a collecting device to collect coating solution unused for spray coating.

13. The spray coating device of claim 1,
wherein the coating solution scatter prevention means includes a gas supply device to supply gas to a gap between a substrate having a ink absorption layer on the backup roller and a lower plate of the body.

14. The spray coating device of claim 1,
wherein the coating solution scatter prevention means is set on at least one of a downstream side and an upstream side of the spray coater.

15. The spray coating device of claim 1,
wherein the spray coating device is set outside a drying process.

16. A spray coating method for coating of a surface layer of an inkjet recording sheet, to form a surface layer by spraying coating solution onto at least one layer of ink absorption layer formed on a substrate by using a spray coating device, comprising steps of:
conveying a substrate continuously by a backup roller;
carrying out spray coating of coating solution onto a substrate with a spray coater near the backup roller; and
preventing sprayed coating solution from scattering by reducing pressure in a body;
wherein a coating solution scatter prevention means which includes the body having a box-shaped structure with an opening on a side of the spray coater and a suction device connected to the body to reduce pressure in the body is positioned in contact with a wall of the spray coater extending in a longitudinal direction of the spray coater and close to an circumferential surface of the backup roller so that a part of the opening is ensured between the spray coater and a substrate.

17. The spray coating method of claim 16, further comprising:
a step of monitoring a spray condition of coating solution sprayed from the spray coater by a monitoring device.

18. The spray coating method of claim 17, further comprising steps of:
transferring the spray coater to a standby position by a transfer device before coating of coating solution on an ink absorption layer; and
monitoring a spray condition of coating solution from the spray coater by the monitoring device;
transferring the spray coater to a coating position by the transfer device;
applying spray coating of coating solution on an ink absorption layer; and
transferring the spray coater to the standby position by the transfer device after coating finishes.

19. The spray coating method of claim 16,
wherein an area of the opening is 100 to 700 percent relative to a spray area and a gas suction quantity of the suction device is 100 to 300 percent relative to an air supply quantity of the spray coater.

20. The spray coating method of claim 18,
wherein a shutter which opens and closes is placed between the standby position and the coating position, synchronizing with a transfer of the spray coater.

21. The spray coating method of claim 18,
wherein an upper plate of the body of the coating solution scatter prevention means placed on a transfer side of the spray coater to the standby position is transferred linked with the spray coater.

22. The spray coating method of claim 18,
wherein while the spray coater is transferred to the standby position, the spray coater is spraying coating solution.

23. The spray coating method of claim 16,
wherein the spray coater is a curtain spray coater.

24. The spray coating method of claim 16,
wherein the ink absorption layer comprises at least one layer of inorganic fine particles and a porous layer including a binder.

25. The spray coating method of claim 16,
wherein a current regulating device is installed inside the body.

26. The spray coating method of claim 17,
wherein the monitoring device is positioned opposite the coating solution scatter prevention means and always monitors a spray condition of coating solution sprayed from the spray coater and then feeds back information of a location of abnormal coating to a coating record.

27. The spray coating method of claim 16,
wherein the coating solution scatter prevention means is transferred from a standby position to a set position linked with a transfer of the spray coater from a standby position to a coating position.

28. The spray coating method of claim 16,
wherein the coating solution scatter prevention means includes a collecting device to collect coating solution unused for spray coating.

29. The spray coating method of claim 16,
wherein the coating solution scatter prevention means includes a gas supply device to supply gas to a gap between a substrate having a ink absorption layer on the backup roller and a lower plate of the body.

30. The spray coating method of claim 16,
wherein the coating solution scatter prevention means is set on at least one of a downstream side and an upstream side of the spray coater.

31. The spray coating method of claim 16,
wherein the spray coating device is set outside a drying process.

32. The spray coating method of claim 16,
wherein a surface layer is formed by carrying out spray coating of coating solution across total width in a width direction of an ink absorption layer by using a spray coating device set at a position crossing a conveyance direction of a substrate.

33. An inkjet recording sheet,
wherein the inkjet recording sheet is produced by the spray coating device of claim 1.
